(19) United States
(12) Patent Application Publication
(10) Pub. No.: US 2025/0256301 A1
(43) Pub. Date: Aug. 14, 2025

(54) NANOCOMPOSITE AND METHOD OF MAKING THE SAME

(71) Applicant: The Texas A&M University System, Cpllege Station, TX (US)

(72) Inventors: Jaime C. Grunlan, College Station, TX (US); Ethan T. Iverson, Adkins, TX (US)

(21) Appl. No.: 18/849,273

(22) PCT Filed: Mar. 21, 2023
(86) PCT No.: PCT/US2023/064767

§ 371 Date: Sep. 20, 2024

Related U.S. Application Data
(60) Provisional application No. 63/269,668, filed on Mar. 21, 2022.

(51) Int. Cl. B05D 7/00; B01D 1/18; B82Y 30/00; B82Y 40/00; H01B 3/00

(52) U.S. Cl. CPC B05D 7/51; B01D 1/18; B82Y 30/00; B82Y 40/00; H01B 3/008

(57) ABSTRACT

A nanocomposite includes a stack that includes at least one bilayer. Each of the bilayers independently includes an anionic layer and cationic layer. The anionic layer includes a polyanionic polymer, first particles, or a combination thereof. The cationic layer includes a polycationic polymer, second particles, or a combination thereof. The anionic layer is in planar contact with the cationic layer. In each of the bilayers, the anionic layer includes the polyanionic polymer, the cationic includes the polycationic polymer, or a combination thereof.

### CROSS-REFERENCE TO RELATED APPLICATION

This application claims the benefit of priority to U.S. Provisional Patent Application Ser. No. 63/269,668 filed Mar. 21, 2022, the disclosure of which is incorporated herein in its entirety by reference.

### STATEMENT OF GOVERNMENT SUPPORT

This invention was made with Government support under DE-AR0001356 awarded by the Department of Energy. The U.S. Government has certain rights in this invention.

### BACKGROUND

Technology ranging from aerospace and military gadgets to energy storage and conversion systems have experienced a significant increase in complexity, power draw, and heat generation. An extensive amount of research has focused on creating and improving materials that can be used as electrical insulation, energy storage devices, thermal management systems, and combinations thereof, due to technology's rapid development. One critical sector of research focuses on a new generation of dielectrics that have higher breakdown strength and also have improved through-plane thermal conductivity. However this sector has been plagued with stunted development due to a dielectric material's thermal conductivity and breakdown strength typically being inversely related to one another.

The through-plane thermal conductivity of electrical insulation is becoming a prominent property to optimize as next generation's technology produces far more heat due to higher power densities and power draws. With elevated temperatures, insulation can experience a mechanism of dielectric breakdown called thermal breakdown. In short, thermal breakdown is the buildup of thermal energy as power draw is increased leading to thermal runaway (i.e., heat generation exceeds heat expulsion). While state-of-the-art technology will throttle power density and power draw when temperatures get too high, thermal runaway can and still occurs. Another approach commonly employed in aviation and electronic vehicles for limiting dielectric materials' temperature exposure is implementing a cooling system. While this approach historically has been successful, it adds 1) unwanted weight to the technology (which decreases power density) and 2) can significantly increase the cost associated with the technology. In tandem with power throttling and cooling systems, more emphasis should be placed on the design of thermal management systems at a molecular level (i.e., chemical composition) so that the materials' through-plane thermal conductivity can be increased.

### SUMMARY OF THE INVENTION

In various aspects, the present invention provides a nanocomposite including a stack that includes at least one bilayer. Each of the bilayers independently includes an anionic layer and a cationic layer. The anionic layer includes a polyanionic polymer, first particles, or a combination thereof. The cationic layer includes a polycationic polymer, second particles, or a combination thereof. The anionic layer is in planar contact with the cationic layer. In each of the bilayers, the anionic layer includes the polyanionic polymer, the cationic layer includes the polycationic polymer, or a combination thereof.

In various aspects, the present invention provides a nanocomposite that includes a stack that includes at least two bilayers in planar contact with one another. Each of the bilayers independently includes an anionic layer and a cationic layer. The anionic layer includes polyacrylic acid and first particles including vermiculite, hexagonal boron nitride, or a combination thereof. The cationic layer includes polyethylenimine and second particles including boehmite, mica, or a combination thereof. The anionic layer is in planar contact with the cationic layer. The anionic layer and the cationic layer of the two or more bilayers form an alternating arrangement in the stack. The thermal conductivity of the nanocomposite times dielectric breakdown strength of the nanocomposite at room temperature is 33 kW*MV/m²*K to 150 kW*MV/m²*K.

In various aspects, the present invention provides a method of forming a nanocomposite. The method includes treating a substrate with an anionic solution including polyacrylic acid and first particles including vermiculite, hexagonal boron nitride, or a combination thereof. The method includes, before or after treating the substrate with the anionic solution, treating the substrate with a cationic solution including polyethylenimine and first particles including boehmite, mica, or a combination thereof. The method includes repeating the treating of the substrate with the anionic solution and the treating of the substrate with the cationic solution in an alternating fashion, to form the nanocomposite. The nanocomposite includes a stack including at least two adjacent bilayers in planar contact with one another. Each of the bilayers independently includes an anionic layer and a cationic layer. The anionic layer includes polyacrylic acid and first particles including vermiculite, hexagonal boron nitride, or a combination thereof. The cationic layer includes polyethylenimine and second particles including boehmite, mica, or a combination thereof. The anionic layer is in planar contact with the cationic layer. The anionic layer and the cationic layer of the two or more bilayers form an alternating arrangement in the stack. The thermal conductivity of the nanocomposite times dielectric breakdown strength of the nanocomposite at room temperature is 33 kW*MV/m²*K to 150 kW*MV/m²*K.

Various aspects of the nanocomposite of the present invention provide various advantages over conventional materials. For example, in various aspects, the nanocomposite of the present invention can provide higher through-plane thermal conductivity, higher dielectric breakdown strength, or a combination thereof, as compared to other materials. In various aspects, the product of the thermal conductivity and the dielectric breakdown strength can be higher than that of other materials. By providing higher through-plane thermal conductivity, various aspects of the nanocomposite of the present invention can dissipate more heat which allows for higher operating temperatures (e.g., due to lower risk of thermal runaway) and higher power densities and power draws. In various aspects, the nanocomposite of the present invention can have increased dielectric breakdown strength, modulus, and hydrophobicity at elevated temperatures. In various aspects, the nanocomposite of the present invention can be more efficiently fabricated than other materials, and the fabrication thereof can be more easily and efficiently scaled than fabrication methods for other materials. In various aspects, the nanocomposite can be applied more conformally to diverse substrates (e.g., substrates with high complexity) and can be applied in a more scalable way (e.g., the thickness can be easily varied) as compared to other nanocomposites and methods of forming the same.

### BRIEF DESCRIPTION OF THE FIGURES

The drawings illustrate generally, by way of example, but not by way of limitation, various aspects of the present invention.

FIG. 1A illustrates a schematic showing an LbL deposition process and cross-sectional TEM image of the nanocomposite, in accordance with various aspects.

FIG. 1B illustrates chemical structures of PEI, PAA, BMT, and VMT, in accordance with various aspects.

FIG. 2A illustrates a schematic of a custom-built 3-omega setup, in accordance with various aspects.

FIG. 2B illustrates 3ω sample geometry, in accordance with various aspects.

FIG. 3A illustrates temperature amplitude versus frequency for 5 BL 0.1 wt % PEI 0.5 wt % BMT/0.1 wt % PAA 1 wt % VMT nanocomposite film, in accordance with various aspects.

FIG. 3B illustrates temperature amplitude versus frequency for 7 BL 0.1 wt % PEI 0.5 wt % BMT/0.1 wt % PAA 1 wt % VMT nanocomposite film, in accordance with various aspects.

FIG. 3C illustrates temperature amplitude versus frequency for 10 BL 0.1 wt % PEI 0.5 wt % BMT/0.1 wt % PAA 1 wt % VMT nanocomposite film, in accordance with various aspects.

FIG. 3D illustrates thickness dependence of total thermal resistance of film, in accordance with various aspects.

FIG. 4A illustrates a plot showing breakdown strength versus thermal conductivity for various nanocomposites, in accordance with various aspects.

FIG. 4B illustrates a plot showing dielectric breakdown strength versus thermal conductivity and filler wt % for various nanocomposites, in accordance with various aspects.

FIG. 5A illustrates probability of failure versus dielectric breakdown strength for systems with various fillers, in accordance with various aspects.

FIG. 5B illustrates dielectric loss versus frequency for systems with various fillers, in accordance with various aspects.

FIG. 5C illustrates dielectric constant versus frequency for systems with various fillers, in accordance with various aspects.

FIG. 6 illustrates a cross sectional transmission electron microscopy micrograph of a PEI+BMT/PAA+VMT nanocomposite, in accordance with various aspects.

FIG. 7A illustrates probability of failure versus dielectric breakdown strength for PEI+BMT/PAA+VMT at 20° C. and 80° C., in accordance with various aspects.

FIG. 7B illustrates dielectric loss versus frequency for PEI+BMT/PAA+VMT at 20° C. and 80° C., in accordance with various aspects.

FIG. 7C illustrates dielectric constant versus frequency for PEI+BMT/PAA+VMT at 20° C. and 80° C., in accordance with various aspects.

FIG. 8 illustrates an FT-IR spectrum of a PEI+BMT/PAA+VMT nanocomposite after room temper urate and elevated temperature testing, in accordance with various aspects.

FIG. 9 illustrates water contact angles of nanocomposites and a PEI/PAA matrix, in accordance with various aspects.

FIG. 10 illustrates TGA thermographs of mass percentage versus temperature for PEI+BMT/PAA, PEI/PAA+VMT, and PEI+BMT/PAA+VMT nanocomposites, in accordance with various aspects.

FIG. 11A illustrates an AFM image showing morphology of a nanocomposite before elevated temperature exposure, in accordance with various aspects.

FIG. 11B illustrates an AFM image showing morphology of the nanocomposite from FIG. 11A after elevated temperature exposure, in accordance with various aspects.

FIG. 11C illustrates a SEM image showing morphology of a nanocomposite before elevated temperature exposure, in accordance with various aspects.

FIG. 11D illustrates a SEM image showing morphology of the nanocomposite from FIG. 11C after elevated temperature exposure, in accordance with various aspects.

FIG. 12 illustrates a growth curve showing thickness versus number of BL for a PEI+BMT/PAA+VMT nanocomposite, in accordance with various aspects.

FIG. 13A illustrates a schematic showing a layer-by-layer deposition process used to prepare functional thin films, in accordance with various aspects.

FIG. 13B illustrates bilayers generated on a substrate from repetition of the steps shown in FIG. 1A, in accordance with various aspects.

FIG. 14A illustrates a 3BL assembly of boehmite and vermiculite clay (top), a TEM cross-section micrograph of a 3BL assembly of boehmite and vermiculite clay (middle), and characteristic d-spacing of VMT and BMT platelets (bottom).

FIG. 14B illustrates a TEM cross section of cotton fiber with 20 BL PEI/colloidal silica coating.

FIG. 14C illustrates a schematic showing layer-by-layer deposition of a chitosan/vermiculite nanobrick wall coating on a flexible polyurethane foam (top), and SEM images of uncoated and coated PUF (middle left, and bottom left, respectively), EPMA Al X-Ray mapping of coated PUF (middle right), and TEM cross-sectional micrograph of 8BL CH/VMT deposited on PUF (bottom right).

FIG. 14D illustrates a TEM cross-sectional image of alternating “stripes” of 13 BL PEI/VMT and 40 BL colloidal silica/cellulose nanocrystals (top left) intended to mimic the iridescent beetle shell shown in the photograph (top right), and an SEM cross-sectional image of this film (bottom).

FIGS. 15A-15C illustrate schematic images of nanostructures that can be produced using layer-by-layer assembly of anionic and cationic particles and/or polymers, including using positively-charged particles deposited in every other layer and alternating with a negatively-charged particle (15A), using a stack of two different bilayer systems (15B), or various types of quad-layer assemblies can be generating using the technique (15C), in accordance with various aspects.

FIG. 16A illustrates a layer-by-layer schematic for a PEI-BMT/PAA-VMT film, in accordance with various aspects.

FIG. 16B illustrates chemical structures of boehmite (BMT), vermiculite clay (VMT), mica, hexagonal boron nitride (hBN), polyethylenimine (PEI), and poly(acrylic acid) (PAA), in accordance with various aspects.

FIG. 16C illustrates a growth curve showing thickness versus number of BL for a 0.1% PEI-0.5% BMT/0.1% PAA-1% VMT system, in accordance with various aspects.

FIG. 16D illustrates a growth curve showing thickness versus number of BL for a 0.2 wt % PEI-0.5 wt % mica/0.5 wt % PAA-0.5 wt % h-BN system, in accordance with various aspects.

FIG. 17A-17C illustrate various schematics of a 3-omega sample configuration, in accordance with various aspects.

FIG. 18A illustrates temperature amplitude as a function of frequency for 4 BL 0.2 wt % PEI-0.5 wt % mica/0.5 wt % PAA-0.5 wt % h-BN nanocomposite film, in accordance with various aspects.

FIG. 18B illustrates temperature amplitude as a function of frequency for 6 BL 0.2 wt % PEI-0.5 wt % mica/0.5 wt % PAA-0.5 wt % h-BN nanocomposite film, in accordance with various aspects.

FIG. 18C illustrates temperature amplitude as a function of frequency for 8 BL 0.2 wt % PEI-0.5 wt % mica/0.5 wt % PAA-0.5 wt % h-BN nanocomposite film, in accordance with various aspects.

FIG. 19 illustrates effective resistance as a function of thickness (t) for 4, 6, and 8 BL of 0.2 wt % PEI-0.5 wt % mica/0.5 wt % PAA-0.5 wt % h-BN system, in accordance with various aspects.

FIG. 20 illustrates a schematic representation of a dielectric breakdown treating station, in accordance with various aspects.

FIG. 21A illustrates probability of failure as a function of breakdown strength for 4 BL of 0.2 wt % PEI-0.5 wt % mica/0.5 wt % PAA-0.5 wt % h-BN, in accordance with various aspects.

FIG. 21B illustrates probability of failure as a function of breakdown strength for 6 BL of 0.2 wt % PEI-0.5 wt % mica/0.5 wt % PAA-0.5 wt % h-BN, in accordance with various aspects.

FIG. 21C illustrates probability of failure as a function of breakdown strength for 8 BL of 0.2 wt % PEI-0.5 wt % mica/0.5 wt % PAA-0.5 wt % h-BN, in accordance with various aspects.

FIG. 22A illustrates a TGA curve showing weight change versus temperature for 0.1% PEI-0.5% BMT/0.1% PAA-1% VMT from 100° C. to 700° C., in accordance with various aspects.

FIG. 22B illustrates a TGA curve showing weight change versus temperature for 0.2 wt % PEI-0.5 wt % mica/0.5 wt % PAA-0.5 wt % h-BN from 100° C. to 700° C., in accordance with various aspects.

FIG. 23 illustrates a TEM micrograph of 0.1% PEI-0.5% BMT/0.1% PAA-1% VMT at 30 BL, in accordance with various aspects.

FIG. 24 illustrates thickness versus BL number for 0.2 wt % PEI+0.5 wt % mica/0.5 wt % PAA+0.5 wt % h-BN, in accordance with various aspects.

FIGS. 25A-25F illustrate dielectric constant versus frequency and dielectric loss versus frequency for crosslinked and uncrosslinked 0.2 wt % PEI+0.5 wt % mica/0.5 wt % PAA+0.5 wt % h-BN with 6 bilayers (FIGS. 25A and 25B), 8 bilayers (FIGS. 25C and 25D), and 10 bilayers (FIGS. 25E and 25F), in accordance with various aspects.

FIG. 26 illustrates thermal conductivity versus dielectric constant for various materials, including for 0.2 wt % PEI+0.5 wt % mica/0.5 wt % PAA+0.5 wt % h-BN, in accordance with various aspects.

FIG. 27A illustrates dielectric constant versus frequency for crosslinked and uncrosslinked 0.2 wt % PEI+0.5 wt % mica/0.5 wt % PAA+0.5 wt % h-BN with 6 bilayers, in accordance with various aspects.

FIG. 27B illustrates dielectric loss versus frequency for crosslinked and uncrosslinked 0.2 wt % PEI+0.5 wt % mica/0.5 wt % PAA+0.5 wt % h-BN with 6 bilayers, in accordance with various aspects.

### DETAILED DESCRIPTION OF THE INVENTION

Reference will now be made in detail to certain aspects of the disclosed subject matter. While the disclosed subject matter will be described in conjunction with the enumerated claims, it will be understood that the exemplified subject matter is not intended to limit the claims to the disclosed subject matter.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” or “at least one of A or B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

In the methods described herein, the acts can be carried out in a specific order as recited herein. Alternatively, in any aspect(s) disclosed herein, specific acts may be carried out in any order without departing from the principles of the invention, except when a temporal or operational sequence is explicitly recited. Furthermore, specified acts can be carried out concurrently unless explicit claim language recites that they be carried out separately or the plain meaning of the claims would require it. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%. The term “substantially free of” as used herein can mean having none or having a trivial amount of, such that the amount of material present does not affect the material properties of the composition including the material, such that about 0 wt % to about 5 wt % of the composition is the material, or about 0 wt % to about 1 wt %, or about 5 wt % or less, or less than, equal to, or greater than about 4.5 wt %, 4, 3.5, 3, 2.5, 2, 1.5, 1, 0.9, 0.8, 0.7, 0.6, 0.5, 0.4, 0.3, 0.2, 0.1, 0.01, or about 0.001 wt/or less, or about 0 wt %.

### Nanocomposite.

In various aspects, the present invention provides a nanocomposite. The nanocomposite includes or is a stack that includes at least one bilayer. Each of the bilayers independently includes an anionic layer and a cationic layer. The anionic layer includes a polyanionic polymer, first particles, or a combination thereof. The cationic layer includes a polycationic polymer, second particles, or a combination thereof. The anionic layer is in planar contact with the cationic layer. In each of the bilayers, the anionic layer includes the polyanionic polymer, the cationic layer includes the polycationic polymer, or a combination thereof. As used here, a layer being “in planar contact” with another layer means that a major face of one layer is in contact with a major face of another layer, and in various aspects can also mean that a majority (e.g., over 50%) or about all (e.g., about 100%) of the surface area of a major face of one layer contacts a major face of another layer. The nanocomposite can be in the form of a thin film that is a stack including the at least one bilayer. Each layer can be ionically crosslinked.

The nanocomposite can include two or more of the bilayers. The at least two bilayers can be adjacent bilayers that contact one another as adjacent layers in the stack. The anionic layer of one of the at least two bilayers can be in planar contact with the cationic layer of another one of the at least two bilayers. The anionic layer and the cationic layer of the two of more bilayers can form an alternating arrangement in the stack (e.g., anionic layer/cationic layer/anionic layer/cationic layer or cationic layer/anionic layer/cationic layer/anionic layer).

In various aspects, the anionic layer can include the polyanionic polymer and the cationic layer can include the polycationic polymer and the second particles. In various aspects, the anionic layer can include the polyanionic polymer and the first particles and the cationic layer can include the polycationic polymer. In various aspects, the anionic layer includes the polyanionic polymer and the first particles, and wherein the cationic layer includes the polycationic polymer and the second particles.

In various aspects, the nanocomposite can consist of the one or more bilayers. In other aspects, the nanocomposite can include one or more other components, such as one or more additional layers. For example, the nanocomposite can further include one or more additional bilayers that each independently include an additional anionic layer and an additional cationic layer. The additional anionic layer can include the first particles. The additional cationic layer can include the second particles. The additional anionic layer can be in planar contact with the additional cationic layer. At least one of the additional bilayers is in planar contact with at least one of the at least one bilayer: at least one of the additional anionic layers is in planar contact with the cationic layer of at least one of the bilayers, or at least one of the additional cationic layers is in planar contact with the anionic layer of at least one of the bilayers, or a combination thereof. In various aspects, the nanocomposite can consist of the one or more bilayers and the one or more additional layers.

The stack can have any suitable thickness. For example, the stack can have a thickness of 1 nm to 1,000 microns, or 10 nm to 20 microns, or less than or equal to 1,000 microns and greater than or equal to 1 nm and less than, equal to, or greater than 1 nm, 2, 4, 6, 8, 10, 12, 14, 16, 18, 20, 25, 30, 35, 40, 45, 50, 60, 70, 80, 90, 100, 150, 200, 250, 300, 400, 500, 600, 800 nm, 1 micron, 2, 3, 4, 5, 6, 8, 10, 12, 14, 16, 18, 20, 25, 30, 35, 40, 45, 50, 60, 70, 80, 90, 100, 150, 200, 250, 300, 400, 500, 600, 700, 800, or 900 microns.

The stack can include any suitable number of the bilayers. For example, the stack can include 1 to 2,000 of the bilayers, or 1 to 200, or 1 to 20, or 2 to 12, or less than or equal to 200 and greater than or equal to 1 and less than, equal to, or greater than 2, 3, 4, 5, 6, 7, 8, 9, 10, 11, 12, 13, 14, 15, 16, 17, 18, 19, 20, 22, 24, 26, 28, 30, 35, 40, 45, 50, 60, 70, 80, 90, 100, 125, 150, 175, 200, 250, 500, 750, 1,000, 1,250, 1,500, or 1,750 bilayers. The stack can include any suitable number of the additional bilayers; for example, the stack can include 0 to 200 of the additional bilayers, or 0 to 20 of the additional bilayers, or less than or equal to 200 and greater than or equal to 0 and less than, equal to, or greater than 1, 2, 3, 4, 5, 6, 7, 8, 9, 10, 11, 12, 13, 14, 15, 16, 17, 18, 19, 20, 22, 24, 26, 28, 30, 35, 40, 45, 50, 60, 70, 80, 90, 100, 125, 150, 175, or 190 additional bilayers.

Each of the bilayers and/or the additional bilayers can independently have any suitable thickness, such as a thickness of 2 nm to 400 nm, 2 nm to 100 nm, or less than or equal to 400 nm and greater than or equal to 2 nm and less than, equal to, or greater than 3, 4, 5, 6, 7, 8, 9, 10, 12, 14, 16, 18, 20, 22, 24, 26, 28, 30, 35, 40, 45, 50, 60, 70, 80, 90, 100, 120, 140, 160, 180, 200, 220, 240, 260, 280, 300, 320, 340, 360, or 380 nm.

The polyanionic polymer can include any suitable polyanionic polymer. The polyanionic polymer can include or be polyacrylic acid, polystyrene sulfonate, poly(vinylsulfonic acid), poly(methyl vinyl ether-alt-maleic acid), poly(methacrylic acid), or a combination thereof. The polyanionic polymer can have any suitable weight average molecular weight, such as 100 g/mol to 4,000,000 g/mol, 500 g/mol to 500,000 g/mol, or less than or equal to 4,000,000 g/mol and greater than or equal to 100 g/mol and less than, equal to, or greater than 200, 300, 400, 500, 600, 800, 1K, 2K, 4K, 6K, 8K, 10K, 15K, 20K, 30K, 40K, 50K, 60K, 80K, 100K, 150K, 200K, 250K, 300K, 400K, 500K, 600K, 700K, 800K, 900K, 1M, 1.5M, 2M, 2.5M, 3M, or 3.5M g/mol. The polyanionic polymer can be any suitable proportion of the anionic layer or additional anionic layer, such as 0 wt % to 100 wt % of the anionic layer or additional anionic layer, or 0 wt % to 80 wt %, or less than or equal to 100 wt % and greater than or equal to 0 wt % and less than, equal to, or greater than 2 wt %, 4, 6, 8, 10, 12, 14, 16, 18, 20, 22, 24, 26, 28, 30, 32, 34, 36, 38, 40, 42, 44, 46, 48, 50, 52, 54, 56, 58, 60, 62, 64, 66, 68, 70, 72, 74, 76, 78, 80, 82, 84, 86, 88, 90, 92, 94, 96, or 98 wt %. The polyanionic polymer can be any suitable proportion of the nanocomposite, such as 0 wt % to 100 wt % or 0 wt % to 80 wt % of the nanocomposite, or less than or equal to 100 wt % and greater than or equal to 0 wt % and less than, equal to, or greater than 2 wt %, 4, 6, 8, 10, 12, 14, 16, 18, 20, 22, 24, 26, 28, 30, 32, 34, 36, 38, 40, 42, 44, 46, 48, 50, 52, 54, 56, 58, 60, 62, 64, 66, 68, 70, 72, 74, 76, 78, 80, 82, 84, 86, 88, 90, 92, 94, 96, or 98 wt %.

The polycationic polymer can include any suitable polycationic polymer. The polyanionic polymer can include or be chitosan, polyethylenimine, polyvinyl amine, poly(diallylmethylammonium chloride), poly(allylamine), or a combination thereof. The polycationic polymer can have any suitable weight average molecular weight, such as 100 g/mol to 4,000,000 g/mo, or 100 g/mol to 100,000 g/mol, 500 g/mol to 50,000 g/mol, or less than or equal to 4,000,000 g/mol and greater than or equal to 100 g/mol and less than, equal to, or greater than 200, 300, 400, 500, 600, 800, 1K, 2K, 4K, 6K, 8K, 10K, 15K, 20K, 30K, 40K, 50K, 60K, 80K, 100K, 150K, 200K, 250K, 300K, 400K, 500K, 600K, 700K, 800K, 900K, 1M, 1.5M, 2M, 2.5M, 3M, or 3.5M g/mol. The polycationic polymer can be any suitable proportion of the cationic layer or additional cationic layer, such as 0 wt % to 100 wt % or 0 wt % to 80 wt % of the cationic layer or additional cationic layer, or less than or equal to 100 wt % and greater than or equal to 0 wt % and less than, equal to, or greater than 2 wt %, 4, 6, 8, 10, 12, 14, 16, 18, 20, 22, 24, 26, 28, 30, 32, 34, 36, 38, 40, 42, 44, 46, 48, 50, 52, 54, 56, 58, 60, 62, 64, 66, 68, 70, 72, 74, 76, 78, 80, 82, 84, 86, 88, 90, 92, 94, 96, or 98 wt %. The polycationic polymer can be any suitable proportion of the nanocomposite, such as 0 wt % to 100 wt % or 0 wt % to 80 wt % of the nanocomposite, or less than or equal to 80 wt % and greater than or equal to 0 wt % and less than, equal to, or greater than 2 wt %, 4, 6, 8, 10, 12, 14, 16, 18, 20, 22, 24, 26, 28, 30, 32, 34, 36, 38, 40, 42, 44, 46, 48, 50, 52, 54, 56, 58, 60, 62, 64, 66, 68, 70, 72, 74, 76, 78, 80, 82, 84, 86, 88, 90, 92, 94, 96, or 98 wt %.

The first and second particles can independently have any suitable median particle size, such as 1 nm to 10 microns, or 1 nm to 100 nm, or less than or equal to 10 microns and greater than or equal to 1 nm and less than, equal to, or greater than 2 nm, 3, 4, 6, 8, 10, 15, 20, 25, 30, 35, 40, 45, 50, 60, 70, 80, 90, 100, 120, 140, 160, 180, 200, 250, 300, 350, 400, 450, 500, 600, 700, 800, 900 nm, 1 micron, 1.5, 2, 2.5, 3, 3.5, 4, 4.5, 5, 6, 7, 8, or 9 microns. The first and/or second particles can be nanoparticles. The first and second particles independently include clay, boehmite, hexagonal boron nitride, graphene oxide, nanocellulose, colloidal silica, mica, MXenes, vermiculite, montmorillonite, laponite, halloysite, or a combination thereof. The first and second particles can independently include montmorillonite, vermiculite, hexagonal boron nitride, mica, or a combination thereof. The shape of the first and second particles can independently be selected from spherical shapes, flakes, plates, irregular shapes, or a combination thereof.

Any suitable proportion of the nanocomposite can be inorganic materials, wherein the inorganic materials partially or entirely are the first and second particles. For example, 10 wt % to 100 wt % of the nanocomposite can be inorganic materials, or 10 wt % to 80 wt %, or 15 wt % to 65 wt %, or less than or equal to 100 wt % and greater than or equal to 10 wt % and less than, equal to, or greater than 12 wt %, 14, 16, 18, 20, 25, 30, 35, 40, 45, 50, 55, 60, 65, 70, 72, 74, 76, 78, 80, 82, 84, 86, 88, 90, 92, 94, 96, or 98 wt %. The cationic layer can have any suitable weight ratio of the second particles to the polycationic polymer, such as 100:1 to 0.5:1, 10:1 to 5:1, or less than or equal to 100:1 and greater than or equal to 1:2 and less than, equal to, or greater than 90:1, 80:1, 70:1, 60:1, 50:1, 40:1, 30:1, 20:1, 15:1, 14:1, 12:1, 10:1, 9:1, 8:1, 7:1, 8:1, 6:1, 5:1, 4:1, 3:1, 2:1, 1:1, 0.9:1, 0.8:1, 0.7:1, or 0.6:1. The anionic layer can have any suitable weight ratio of the first particles to the polyanionic polymer, such as 100:1 to 0.5:1, 10:1 to 1:1, or less than or equal to 100:1 and greater than or equal to 0.5:1 and less than, equal to, or greater than 90:1, 80:1, 70:1, 60:1, 50:1, 40:1, 30:1, 20:1, 15:1, 14:1, 12:1, 10:1, 9:1, 8:1, 7:1, 8:1, 6:1, 5:1, 4:1, 3:1, 2:1, 1:1, 0.9:1, 0.8:1, 0.7:1, or 0.6:1. The first particles can form any suitable proportion of the anionic layer, such as 0 wt % to 100 wt % of the anionic layer, or 0 wt % to 80 wt %, or less than or equal to 100 wt % and greater than or equal to 0 wt % and less than, equal to, or greater than 2 wt %, 4, 6, 8, 10, 12, 14, 16, 18, 20, 22, 24, 26, 28, 30, 32, 34, 36, 38, 40, 42, 44, 46, 48, 50, 52, 54, 56, 58, 60, 62, 64, 66, 68, 70, 72, 74, 76, 78, 80, 82, 84, 86, 88, 90, 92, 94, 96, or 98 wt %. The second particles can form any suitable proportion of the cationic layer, such as 0 wt % to 100 wt % of the cationic layer, or 0 wt % to 80 wt %, or less than or equal to 100 wt % and greater than or equal to 0 wt % and less than, equal to, or greater than 2 wt %, 4, 6, 8, 10, 12, 14, 16, 18, 20, 22, 24, 26, 28, 30, 32, 34, 36, 38, 40, 42, 44, 46, 48, 50, 52, 54, 56, 58, 60, 62, 64, 66, 68, 70, 72, 74, 76, 78, 80, 82, 84, 86, 88, 90, 92, 94, 96, or 98 wt %. The first and second particles can form any suitable proportion of the nanocomposite, such as 0 wt % to 100 wt %, or 0 wt % to 95 wt %, or less than or equal to 100 wt % and greater than or equal to 0 wt % and less than, equal to, or greater than 2 wt %, 4, 6, 8, 10, 12, 14, 16, 18, 20, 22, 24, 26, 28, 30, 32, 34, 36, 38, 40, 42, 44, 46, 48, 50, 52, 54, 56, 58, 60, 62, 64, 66, 68, 70, 72, 74, 76, 78, 80, 82, 84, 86, 88, 90, 92, 94, 96, or 98 wt %.

At each occurrence, the anionic layer or the additional anionic layer can independently have a thickness of 1 nm to 3 microns, 1 nm to 500 nm, or 1 nm to 200 nm, or 1 nm to 100 nm, or less than or equal to 3 microns and greater than or equal to 1 nm and less than, equal to, or greater than 2, 3, 4, 5, 6, 7, 8, 9, 10, 12, 14, 16, 18, 20, 22, 24, 26, 28, 30, 35, 40, 45, 50, 55, 60, 70, 80, 90, 100, 110, 120, 130, 140, 150, 160, 170, 180, 190, 200, 220, 240, 260, 280, 300, 320, 340, 360, 380, 400, 420, 440, 460, 480, 500, 550, 600, 650, 700, 750, 800, 900 nm, 1 micron, 1.2, 1.4, 1.6, 1.8, 2, or 2.5 microns. The anionic layer or the additional anionic layer can include polyacrylic acid, polystyrene sulfonate, poly(vinylsulfonic acid), poly(methyl vinyl ether-alt-maleic acid), poly(methacrylic acid), vermiculite, hexagonal boron nitride, or a combination thereof. The anionic layer or the additional anionic layer can be formed from treatment with a solution including the polyanionic polymer, the first particles, or a combination thereof.

At each occurrence, the cationic layer or the additional cationic layer can independently have a thickness of 1 nm to 3 microns, 1 nm to 500 nm, or 1 nm to 200 nm, or 1 nm to 100 nm, or less than or equal to 3 microns and greater than or equal to 1 nm and less than, equal to, or greater than 2, 3, 4, 5, 6, 7, 8, 9, 10, 12, 14, 16, 18, 20, 22, 24, 26, 28, 30, 35, 40, 45, 50, 55, 60, 70, 80, 90, 100, 110, 120, 130, 140, 150, 160, 170, 180, 190, 200, 220, 240, 260, 280, 300, 320, 340, 360, 380, 400, 420, 440, 460, 480, 500, 550, 600, 650, 700, 750, 800, 900 nm, 1 micron, 1.2, 1.4, 1.6, 1.8, 2, or 2.5 microns. The cationic layer can include chitosan, polyethylenimine, polyvinyl amine, poly(diallylmethylammonium chloride), poly(allylamine), boehmite, mica, or a combination thereof. The cationic layer can be formed from treatment with a solution including the polycationic polymer, the second particles, or a combination thereof.

In various aspects, the anionic layer can include the polyanionic polymer and the cationic layer can include the polycationic polymer, and the polyanionic polymer and the polycationic polymer are crosslinked (e.g., covalently crosslinked), such as via formation of an amide bond between PEI and PAA. The crosslinking can be thermal crosslinking that is induced via the application of heat. In other aspects, the anionic layer can include the polyanionic polymer and the cationic layer can include the polycationic polymer, and the polyanionic polymer and the polycationic polymer are substantially free of crosslinking therebetween (e.g., thermal crosslinking, such as covalent crosslinking).

The nanocomposite can be on a substrate. For example, one of the bilayers (e.g., the initial bilayer formed) can be in planar contact with the substrate. The substrate can be any suitable substrate, such as including glass, metal, polymer, mineral, fabric, or a combination thereof.

The nanocomposite can have any suitable thermal conductivity (k_{⊥}). For example, the nanocomposite can have a thermal conductivity (k_{⊥}) of 0.01 w/m*K to 5 w/m*K, or 0.19 w/m*K to 0.86 w/m*K, or less than or equal to 5 w/m*K and greater than or equal to 0.01 w/m*K and less than, equal to, or greater than 0.01 w/m*K, 0.05, 0.1, 0.2, 0.25, 0.3, 0.35, 0.4, 0.45, 0.5, 0.55, 0.6, 0.65, 0.7, 0.75, 0.8, 0.85, 0.9, 0.95, 1, 1.2, 1.4, 1.6, 1.8, 2, 2.2, 2.4, 2.6, 2.8, 3, 3.5, 4, or 4.5 w/m*K.

The nanocomposite can have any suitable dielectric breakdown strength at room temperature, such as 10 kV/mm to 4000 kV/mm, 80 kV/mm to 350 kV/mm, 100 kV/mm to 300 kV/mm, or less than or equal to 4000 kV/mm and greater than or equal to 10 kV/mm and less than, equal to, or greater than 20, 30, 40, 50, 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 380, 400, 450, 500, 600, 700, 800, 900, 1,000, 1,200, 1,400, 1,600, 1,800, 2,000, 2,500, 3,000, or 3,500 kV/mm.

The nanocomposite can have any suitable effective thermal conductivity (k_{eff}), such as 0.05 W/m*K to 5 W/m*K, 0.10 W/m*K to 0.2 W/m*K, or less than or equal to 5 W/m*K and greater than or equal to 0.05 W/m*K and less than, equal to, or greater than 0.06 W/m*K, 0.08, 0.1, 0.12, 0.14, 0.16, 0.18, 0.2, 0.22, 0.24, 0.26, 0.28, 0.3, 0.32, 0.34, 0.36, 0.38, 0.4, 0.42, 0.44, 0.46, 0.48, 0.5, 0.55, 0.6, 0.65, 0.7, 0.8, 0.9, 1, 1.2, 1.4, 1.6, 1.8, 2, 2.5, 3, 3.5, 4, or 4.5 W/m*K.

The nanocomposite can have any suitable thermal conductivity times dielectric breakdown strength at room temperature, such as 20 kW*MV/m²*K to 200 kW*MV/m²*K, 33 kW*MV/m²*K to 150 kW*MV/m²*K, or less than or equal to 200 kW*MV/m²*K and greater than or equal to 20 kW*MV/m²*K and less than, equal to, or greater than 21 kW*MV/m²*K, 22, 23, 24, 25, 26, 27, 28, 29, 30, 31, 32, 33, 34, 35, 36, 37, 38, 39, 40, 42, 44, 46, 48, 50, 55, 60, 65, 70, 75, 80, 85, 90, 95, 100, 105, 110, 115, 120, 125, 130, 135, 140, 145, 150, 155, 160, 165, 170, 175, 180, 185, 190, or 195 kW*MV/m²*K.

The nanocomposite can have any suitable dielectric constant at room temperature at and 1 kHz, such as 1 to 50, 1 to 20, 2 to 15, or less than or equal to 50 and greater than or equal to 1 and less than, equal to, or greater than 2, 3, 4, 5, 6, 7, 8, 9, 10, 11, 12, 13, 14, 15, 16, 17, 18, 19, 20, 22, 24, 26, 28, 30, 32, 34, 36, 38, 40, 42, 44, 46, or 48.

In various aspects, the nanocomposite can have optically transparent. In various aspects, the nanocomposite can be optically opaque or translucent.

### Electrical Device.

Various aspects of the present invention provide an electrical device that includes the nanocomposite of the present invention. For example, the electrical device can include a nanocomposite that is a stack that includes at least one bilayer. Each of the bilayers independently includes an anionic layer and a cationic layer. The anionic layer includes a polyanionic polymer, first particles, or a combination thereof. The cationic layer includes a polycationic polymer, second particles, or a combination thereof. The anionic layer is in planar contact with the cationic layer. In each of the bilayers, the anionic layer includes the polyanionic polymer, the cationic layer includes the polycationic polymer, or a combination thereof.

The electrical device can be any suitable electrical device. For example, the electrical device can include motor windings, wire insulation, thermal management systems, computer components, aerospace devices, automobile or truck devices, or a combination thereof. The nanocomposite can be a component of a semiconductor. The nanocomposite can be insulation and/or a coating on an electrically conductive material in the electrical device or on a non-electrically conductive material in the electrical device. The electrical device can be a high-voltage electrical device.

### Method of Forming a Nanocomposite.

Various aspects of the present invention provide a method of forming the nanocomposite of the present invention. The method can include treating a substrate with an anionic solution including the polyanionic polymer, the first particles, or a combination thereof. The method can include, before or after treating the substrate with the anionic solution, treating the substrate with a cationic solution including the polycationic polymer, the second particles, or a combination thereof. The method can also include repeating the treating of the substrate with the anionic solution and the treating of the substrate with the cationic solution in an alternating fashion, to form the nanocomposite. The anionic solution can include the polyanionic polymer, the cationic solution includes the polycationic polymer, or a combination thereof. Each time the substrate is treated with the anionic solution or cationic solution, an additional layer is formed on the substrate (e.g., an anionic layer or a cationic layer, respectively). Each time the treated substrate is again treated, both the substrate and any layers already formed on the substrate are treated. The treatment of the treated substrate can include treating only or substantially only the last anionic or cationic layer formed, or can include treating the entire substrate.

The treatment of the substrate (e.g., the substrate including any layers already formed thereon via successive treatments with the cationic and anionic solution) can be any suitable treatment. The treatment can include spraying, painting, dipping, immersing, or a combination thereof. The treating of the substrate with the anionic solution and the cationic solution includes dipping and/or immersing the substrate in the respective solution, such as for a duration of 1 sec to 10 h, 30 sec to 10 min, or less than or equal to 10 h and greater than or equal to 1 sec and less than, equal to, or greater than 5 sec, 10, 15, 20, 25, 30, 35, 40, 45, 50, 55 sec, 1 min, 1.5, 2, 3, 4, 5, 10, 15, 20, 25, 30, 35, 40, 45, 50, 55 min, 1 h, 1.5, 2, 3, 4, 5, 6, 7, 8, or 9 h. The treatment can be performed at room temperature, or at any suitable temperature. The cationic solution and the anionic solution can each be aqueous or non-aqueous solutions.

The cationic solution can have any suitable weight ratio of the particles to the polycationic polymer, such as 100:1 to 0.5:1, 10:1 to 5:1, or less than or equal to 100:1 and greater than or equal to 1:2 and less than, equal to, or greater than 90:1, 80:1, 70:1, 60:1, 50:1, 40:1, 30:1, 20:1, 15:1, 14:1, 12:1, 10:1, 9:1, 8:1, 7:1, 8:1, 6:1, 5:1, 4:1, 3:1, 2:1, 1:1, 0.9:1, 0.8:1, 0.7:1, or 0.6:1. The cationic solution can include 0.01 wt % to 20 wt % particles (e.g., 0.4 to 1 wt %, or less than or equal to 20 wt % and greater than or equal to 0.01 wt % and less than, equal to, or greater than 0.05 wt %, 0.1, 0.2, 0.3, 0.4, 0.5, 0.6, 0.7, 0.8, 0.9, 1, 1.1, 1.2, 1.3, 1.4, 1.5, 1.6, 1.8, 2, 2.5, 3, 3.5, 4, 4.5, 5, 6, 7, 8, 9, 10, 11, 12, 13, 14, 15, 16, 17, 18, or 19 wt %) and 0.01 wt % to 1 wt % polycationic polymer (e.g., 0.05 to 0.5 wt %, or less than or equal to 1 wt % and greater than or equal to 0.01 wt % and less than, equal to, or greater than 0.1 wt %, 0.15, 0.2, 0.25, 0.3, 0.35, 0.4, 0.45, 0.5, 0.6, 0.7, 0.8, or 0.9 wt %). The cationic solution can have any suitable pH, such as a pH of 1 to 13, 7.5 to 11, 8 to 10, or less than or equal to 13 and greater than or equal to 1 and less than, equal to, or greater than 1.5, 2, 2.5, 3, 3.5, 4, 4.5, 5, 5.5, 6, 6.5, 7, 7.5, 8, 8.5, 9, 9.5, 10, 10.5, 11, 11.5, 12, or 12.5.

The anionic solution can have any suitable weight ratio of the particles to the polyanionic polymer, such as 100:1 to 0.5:1, 10:1 to 1:1, or less than or equal to 100:1 and greater than or equal to 0.5:1 and less than, equal to, or greater than 90:1, 80:1, 70:1, 60:1, 50:1, 40:1, 30:1, 20:1, 15:1, 14:1, 12:1, 10:1, 9:1, 8:1, 7:1, 8:1, 6:1, 5:1, 4:1, 3:1, 2:1, 1:1, 0.9:1, 0.8:1, 0.7:1, or 0.6:1. The anionic solution can include 0.01 wt % to 20 wt % particles (e.g., 0.4 wt % to 1.5 wt %, or less than or equal to 20 wt % and greater than or equal to 0.01 wt % and less than, equal to, or greater than 0.05 wt %, 0.1, 0.2, 0.3, 0.4, 0.5, 0.6, 0.7, 0.8, 0.9, 1, 1.1, 1.2, 1.3, 1.4, 1.5, 1.6, 1.8, 2, 2.5, 3, 3.5, 4, 4.5, 5, 6, 7, 8, 9, 10, 11, 12, 13, 14, 15, 16, 17, 18, or 19 wt %) and 0.01 wt % to 5 wt % polyanionic polymer (e.g., 0.05 wt % to 0.7 wt %, or less than or equal to 5 wt % and greater than or equal to 0.01 wt % and less than, equal to, or greater than 0.05, 0.1, 0.15, 0.2, 0.25, 0.3, 0.35, 0.4, 0.45, 0.5, 0.55, 0.6, 0.65, 0.7, 0.75, 0.8, 0.85, 0.9, 0.95, 1, 1.2, 1.4, 1.6, 1.8, 2, 2.5, 3, 3.5, 4, or 4.5 wt %). The anionic solution can have any suitable pH, such as a pH of 1 to 13, 3 to 6.5, or 4 to 6, or less than or equal to 13 and greater than or equal to 1 and less than, equal to, or greater than 1.5, 2, 2.5, 3, 3.5, 4, 4.5, 5, 5.5, 6, 6.5, 7, 7.5, 8, 8.5, 9, 9.5, 10, 10.5, 11, 11.5, 12, or 12.5.

The method can include rinsing the treated substrate after treating the substrate with the anionic solution and/or the cationic solution (e.g., rinsing the substrate and the one or more anionic or cationic layers formed thereon) using any suitable solvent, such as an aqueous solvent, such as water, or a non-aqueous solvent.

The method can include drying the treated substrate after treating the substrate with the anionic solution and/or the cationic solution.

The method can include heat treating the treated substrate to crosslink polyanionic and polycationic layers of the nanocomposite. The method can be substantially free of heat treating the treatment substrate such that thermal crosslinking (e.g., formation of amide bonds) between polymers of adjacent layers is substantially avoided. The method can include use of a crosslinker to induce covalent crosslinking between the polyanionic polymer and the polycationic polymer; in other aspects, the method is free of an added crosslinker for inducing covalent crosslinking between the polyanionic polymer and the polycationic polymer. The method can include use of a crosslinker to induce covalent crosslinking in the cationic layer (e.g., in the polycationic polymer); in other aspects, the method is free of an added crosslinker for inducing covalent crosslinking in the cationic layer.

### EXAMPLES

Various aspects of the present invention can be better understood by reference to the following Examples which are offered by way of illustration. The present invention is not limited to the Examples given herein.

### Example 1

This Example is believed to be the first report of a polyelectrolyte-based nanocomposite utilized as a thermally conductive and electrically insulating nanodielectric. Through including both BMT and VMT the dielectric breakdown strength is increased by 115% when compared to the PEI/PAA matrix likely due to the high inorganic loading creating a tortuous pathway in the nanocomposite for charge transport. The nanocomposite also boasts a high dielectric breakdown strength and through-plane thermal conductivity, a combination which is difficult to achieve simultaneously. Subjecting the nanocomposite to elevated temperatures was found to increase the breakdown strength, modulus, and hydrophobicity of the nanocomposite likely due to the expulsion of molecular water in and on the surface of the nanocomposite. There are very limited accounts of thermally conductive yet electrically insulating materials to date. This report demonstrates for the first time, a LbL generated nanocomposite that is electrically insulating and thermally conductive. The findings outlined in this Example provide significant progress towards the creation of high-performance insulation systems for tomorrows technology.

Materials. Branched polyethylenimine (PEI, M_{w}=25 kg/mol) and poly(acrylic acid) (PAA, M_{w}=250 kg/mol in a 35 wt % aqueous solution) were purchased from Sigma Aldrich (Milwaukee, WI, USA). Microlite 963++vermiculite clay (VMT, 7.8 wt % aqueous solution) was purchased from Specialty Vermiculite Corp. (Cambridge, MA, USA) and boehmite clay (BMT) was purchased from Esprix Technologies (Sarasota, FL, USA). All molecular weight information was obtained from chemical suppliers and chemicals and clays were used without further manipulation. Aqueous solutions and rinses utilized 18 MΩ deionized (DI) water. All solutions were composed of a mixture of polymer and clay. Cationic solutions were prepared as 0.1 wt % PEI+0.5 wt % BMT aqueous solutions. The PEI+BMT solution was rolled for 24 hours to ensure homogenous dispersion after which the pH was determined to be ≈9. Anionic solutions were prepared as 0.1 wt % PAA+1 wt % VMT aqueous solutions. The PAA+VMT solution was rolled for 24 hours to ensure homogenous dispersion after which the pH was determined to be ≈5. Indium-tin-oxide (ITO) coated glass slides and polished 500 μm-thick undoped silicon wafers were purchased from University Wafer (South Boston, MA, USA). All substrates were rinsed in DI water, followed by an ethanol rinse, and then another DI water rinse. Substrates were then dried with compressed filtered air and subjected to a five-minute plasma cleaning utilizing an ATTO plasma cleaner (Diener Electronic, Ebhausen, Germany).

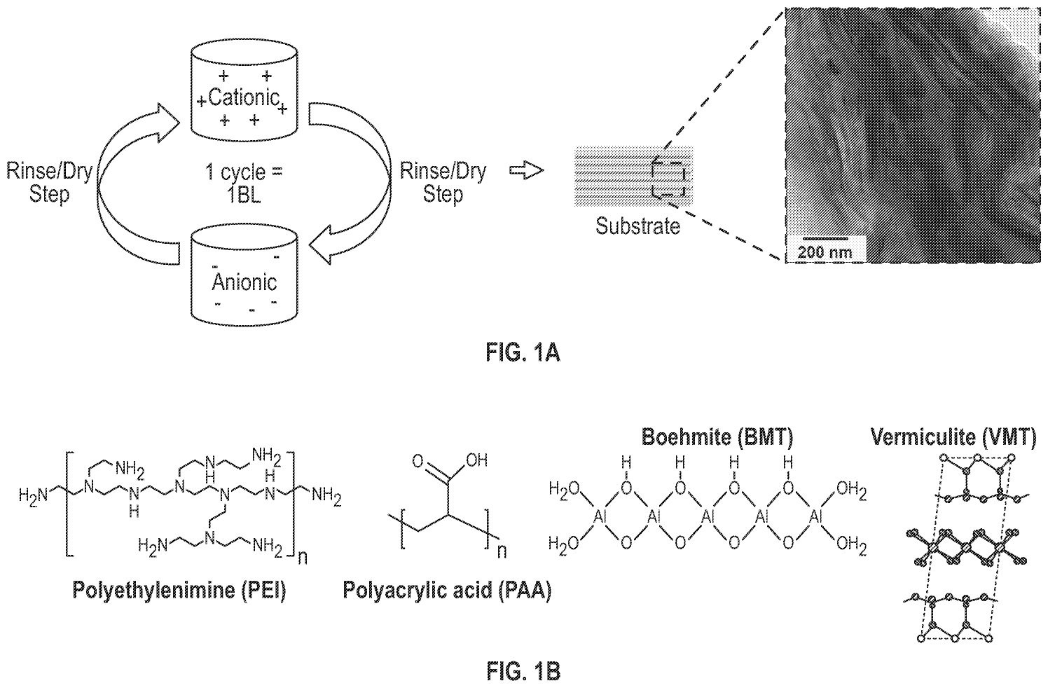

Preparation of Nanocomposites. Nanocomposites were grown by first subjecting plasma-treated substrates into the cationic (PEI+BMT) solution for 5 min followed by a DI water wash and a filtered air blade to remove any loosely adhered material. The substrate was then submerged into the anionic (PAA+VMT) solution for 5 min followed by a DI water wash and filtered air blade to remove any loosely adhered material. This cycle completed the first bilayer (BL), after which all subsequent BL were deposited in a similar fashion, except the dip time was reduced to 1 min. The PEI+BMT/VMT and PEI/PAA+VMT nanocomposites were prepared in the same manner, but the solutions contained only polymers (either PEI and PAA) depending on the nanocomposite. The deposition cycle, chemical structures, as well as a cross-sectional transmission electron microscope (TEM) micrograph are displayed in FIGS. 1A-B. Initial dip times were longer for the first BL to ensure uniform substrate coverage during the initial BL.

Nanocomposite Characterization. Prior to all characterization, nanocomposites were stored in a dry box for approximately 24 h. Nanocomposite thickness and surface roughness values RA and RQ were measured utilizing a KLA-Tencor P-6 Stylus Profiler (Milpitas, CA, USA) or an Alpha-SE ellipsometer (J. A. Woollam Co., Lincoln, NE, USA) depending on film thickness. Each sample had its average thickness and roughness tabulated in triplicate. The absence of crosslinking immediately before and after elevated temperature exposure was confirmed by scrapping the nanocomposites off of the substrate and subjecting the powdered film to Fourier Transform Infrared (FT-IR) spectroscopy using an ALPHA-P10098-4 spectrometer (Bruker Optics Inc., Billerica, MA, USA) in ATR mode. Atomic force microscopy (AFM) was utilized to evaluate the surface morphology of the nanocomposites before and after elevated temperature exposure with a Bruker Dimension Icon (Billerica, MA, USA). Samples were sputter coated with 5 nm of platinum/palladium alloy to prevent charging of the nanocomposite before scanning electron microscopy (SEM) imaging (FESEM, model, JSM-7500, JEOL, JEOL; Tokyo, Japan). TEM samples were prepared by embedding coated PET into Epofix resin (EMS, Hatfield, PA, USA) and cured overnight in a silicone mold. The epoxy block was cut into 90 nm thick cross sections utilizing an Ultra 450 diamond knife (Diatome, Hatfield, PA). TEM micrographs were taken using a Tecnai G2F20 transmission electron microscope (FEI, Hillsboro, OR, USA), with an acceleration voltage of 200 kV. The nanocomposites degradation temperature (T_{5%d}) was determined utilizing a Q-50 thermogravimetric analyzer (TGA, TA Instruments, New Castle, DE, USA). Approximately 3.4 mg of the nanocomposite was isothermally heated at 100° C. for 30 min to remove any residual moisture. The temperature was then increased at a constant rate of 10° C.·min⁻¹ up to 700° C. under a 60 mL·min⁻¹ flow of nitrogen. The nanocomposites reduced modulus (Eᵣ) and hardness (H) before and after elevated temperature exposure was assessed utilizing a TI 950 Triboindenter (Hysitron, Inc., Minneapolis, MN, USA) with a loading force of 200 μN to ensure indentation depth of ≈10%. A loading profile of 10 s of loading, 5 s at a stationary position, and 2 s of unloading was utilized. Surface wettability of the nanocomposite before and after elevated temperature exposure was evaluated utilizing a CAM 200 goniometer optical contact angle and surface tension meter (KSV Instruments, Ltd. Monroe, CT, USA).

Dielectric Properties Characterization. For dielectric characterization nanocomposites were deposited on plasma-treated ITO coated glass slides with a thickness of approximately 700 nm. All characterization occurred in ambient conditions unless specified. The breakdown strength (E_{BD}) was determined utilizing a PolyK test fixture (Philipsburg, PA, USA) and a SCI 290 Hipot tester (Lake Forest, IL) as a DC voltage source. A breakdown event is defined as when a ≥1 mA current was detected. The contact electrode utilized was a spring-loaded stainless-steel cap nut which made contact at constant pressure. Approximately 0.52 mm² of the nanocomposite contacted the spring-loaded stainless-steel cap nut to ensure inhomogeneities did not influence the dielectric breakdown events. For elevated temperature testing, the test fixture was placed onto a hotplate and the temperature of the nanocomposite was monitored utilizing both a Fluke 64 MAX IR thermometer (Everett, Washington, USA) and a Fluke Thermocouple Thermometer utilizing a type K thermocouple (Everett, Washington, USA). Prior to breakdown testing, the thermocouple was removed to prevent any short circuiting. Fifteen breakdown values were utilized for a Weibull probability of failure analysis to tabulate the nanocomposites E_{BD}. Breakdown strength is defined as the breakdown strength at 63.2% of the probability of failure. Nanocomposite thickness and breakdown voltage values were utilized in conjunction to record E_{BD}. A distance ≥3 mm separated each testing location to prevent previous breakdown events from influencing the next testing site. Stainless-steel cap nuts were changed out in between every five breakdown events to prevent tip corrosion from altering the nanocomposites' breakdown strength. The dielectric constant (k) and loss was measured using a Kesight E4980AL/102 Precision LCR Meter (Keysight Technology, Santa Rosa, CA, USA). A gallium-indium eutectic compound was utilized as the top electrode contacting an area of approximately 0.65 mm². Elevated temperature testing occurred by placing the sample onto a hot plate at the desired temperature.

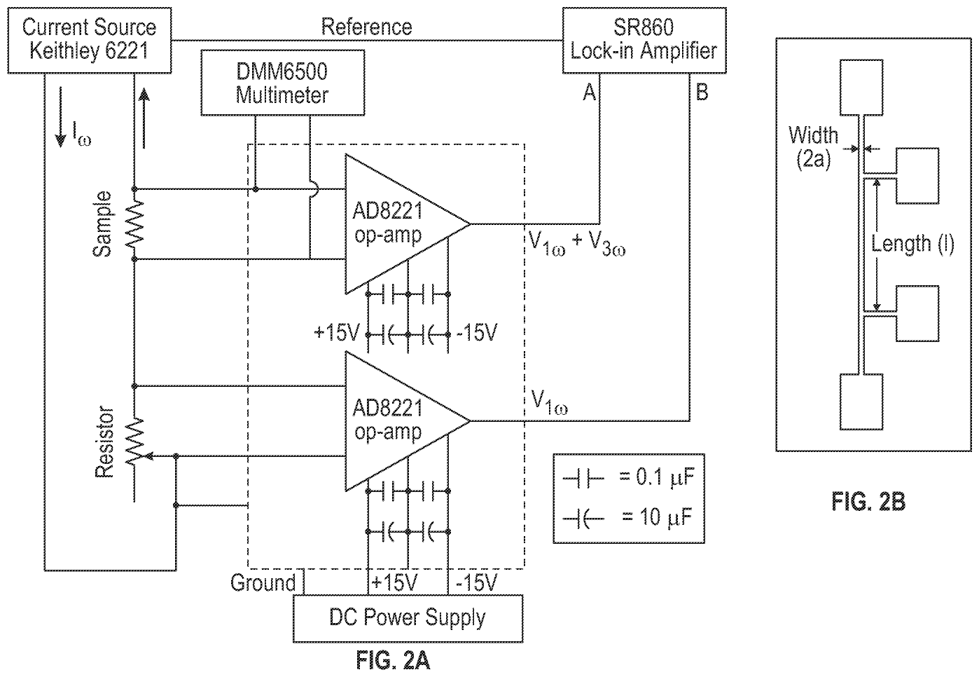

Thermal Conductivity Characterization. The through-plane thermal conductivity (k_{⊥}) of the nanocomposites was measured by the 30) technique using a custom-built setup (see FIG. 2A). The AC current (I_{ω}) is generated by Keithley 6221 current source. A variable resistor is connected in series to compensate the first harmonic voltage (V_{1ω}) from the sample. The third harmonic voltage (V_{3ω}) is measured by the lock-in amplifier (SR 860). A shadow mask electron beam deposition technique was used to deposit aluminum (Al) metal line in a 4-probe pattern that acts both as a heater and sensor. The dimensions of the heater line were 5 mm long, 25 to 100 μm wide, and 250 nm thick. A 25 nm titanium (Ti) layer was deposited on top of the film prior to deposition of Al line to improve adhesion. The schematic of sample geometry is shown in FIG. 2B.

Calibration of the 3ω system was performed by measuring the thermal conductivity of standard materials—fused quartz, Pyrex 7740, Si (undoped), and single crystal sapphire (c-plane orientation) substrates and is detailed in depth in a previous paper which uses the same procedure. In brief, the heater line was calibrated first by measuring the temperature dependence of resistance (dR/dT) and determining the temperature coefficient of resistance (TCR) of the Al line for each sample. The TCR of the Al line deposited was in the range 0.002 to 0.003/K. The relative uncertainty in the measurement of thermal conductivity of standards was within 4%. The thermal conductivity values of the standard substrates thus measured were 1.38±0.06, 1.14±0.05, 41.1±1.6, and 146.5±5.9 W·m⁻¹·K·⁻¹ for fused quartz, Pyrex 7740, sapphire, and silicon, respectively at room temperature. The obtained k values are in good agreement with those reported for these standard materials as shown in Table 1.

TABLE 1
Measured and reported values of thermal
conductivity of standard substrates.

| | Measured | Reported |
|---|---|---|
| Material | k (W · m⁻¹ · K⁻¹) | k (W · m⁻¹ · K⁻¹) |
| Fused Quartz | 1.38 ± 0.06 | 1.3-1.39 |
| Pyrex 7740 | 1.14 ± 0.05 | 1.11-1.26 |
| Sapphire | 41.1 ± 1.6 | 34.84-42.65 |
| Silicon | 146.5 ± 5.9 | 128-156 |

### Breakdown Strength and Thermal Conductivity as a Function of Thickness.

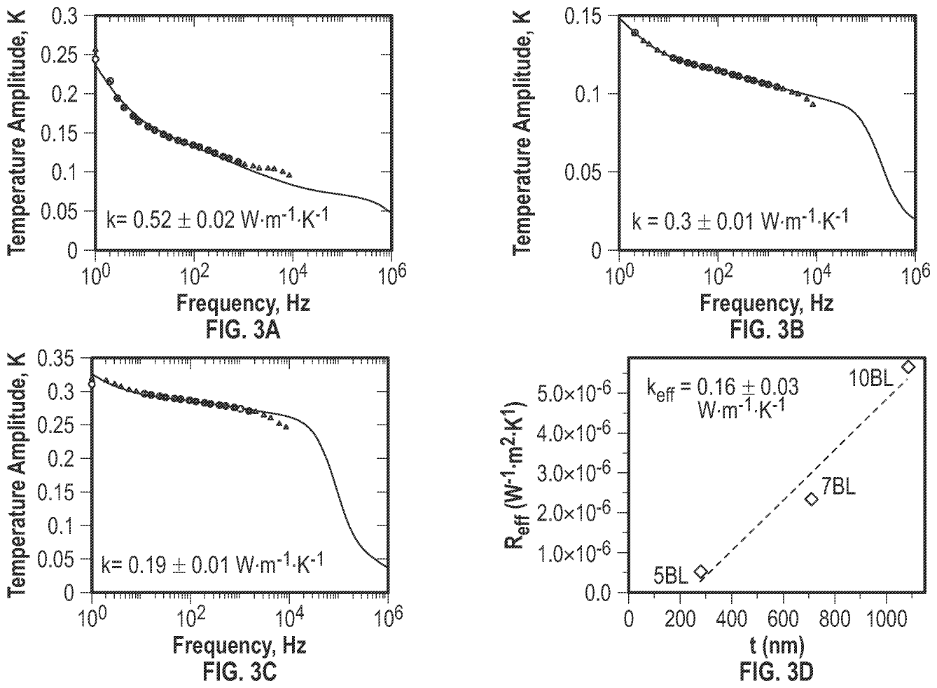

The thermal conductivity values of the bulk substrates (undoped silicon) and the nanocomposite at various thicknesses as well as the effective thermal conductivity of the nanocomposite was determined by fitting the experimental data (temperature amplitude (ΔT) vs current frequency (f)), following the data reduction method proposed by Tong et. Al. (see FIGS. 3A-C). This method accounts for nonideal effects and defects present in the nanocomposite when calculating thermal conductivity. The thermal conductivity of the underlying undoped silicon substrate was measured separately as a control, and its value of 146.5±5.9 W·m⁻¹·K⁻¹ was used in data fitting. In order to determine the effective thermal conductivity of the nanocomposite, a series of films with varying thickness (t) were prepared and their k values were obtained. From the data presented in Table 2, an inverse relationship between thickness and thermal conductivity is observed, namely, as thickness increases thermal conductivity decreases. Previous work which compared experimental results to existing theoretical models, found that thermal boundary resistance at interfaces in LbL generated nanocomposites significantly impact thermal transport properties. As thickness is increased, it is believed that the amount of interfaces (between platelets and the polymer matrix) also increase, leading to a lower thermal conductivity due to more interfacial thermal resistance.

TABLE 2
Thermal conductivity and breakdown
strength at various thicknesses.

| Thickness | | Thermal Conductivity | Breakdown Strength |
|---|---|---|---|
| (nm) | | (k_{⊥}) (W · m⁻¹ · K⁻¹) | (kV/mm) |
| 280 ± 29 | (5 BL) | 0.52 | 210 |
| 700 ± 10 | (7 BL) | 0.30 | 249 |
| 1100 ± 100 | (10 BL) | 0.19 | 240 |

k_{eff} 0.16 W · m⁻¹ · K⁻¹

From the obtained k_{⊥} values, the total thermal resistance (where resistance equals thickness divided by the thermal conductivity at said thickness) of the composite film was calculated and the values were plotted against the film thickness (see FIG. 3D). The effective thermal conductivity (k_{eff}) of the nanocomposite was then determined using the slope of the linear fit line in the resistance I vs thickness (t) plot. It was determined that the nanocomposite had an effective thermal conductivity of 0.16 W/m⁻¹·K⁻¹. The effective thermal conductivity appears to converge as the thickness of the nanocomposite is increased. Compared to the polymer matrix (PEI/PAA), the nanocomposite demonstrated an increase in thermal conductivity. This drastic increase in thermal conductivity can be attributed to the moderately high loading of BMT (≈27 wt %) which has a thermal conductivity that can range from 3 to 10 W/m⁻¹·K⁻¹. The thermal conductivity of the nanocomposite is believed to be hindered due to the inclusion of VMT which has a thermal conductivity of approximately 0.06 W/m⁻¹K⁻¹. This peculiarly low thermal conductivity is due to VMT's lamellar structure containing large air pockets providing it with impressive electrical and thermal insulating properties. The nanocomposite's breakdown strength was determined to remain relatively unchanged (210-250 kV/mm) in the presented thickness regime. This is likely due to similar microstructures at the various thicknesses, a result of the nanocomposite's ordered nanobrick wall structure. It is believed that at even more elevated thicknesses the nanocomposite's breakdown strength would dwindle due to the thickness effect (i.e., a higher occurrence of defeat sites).

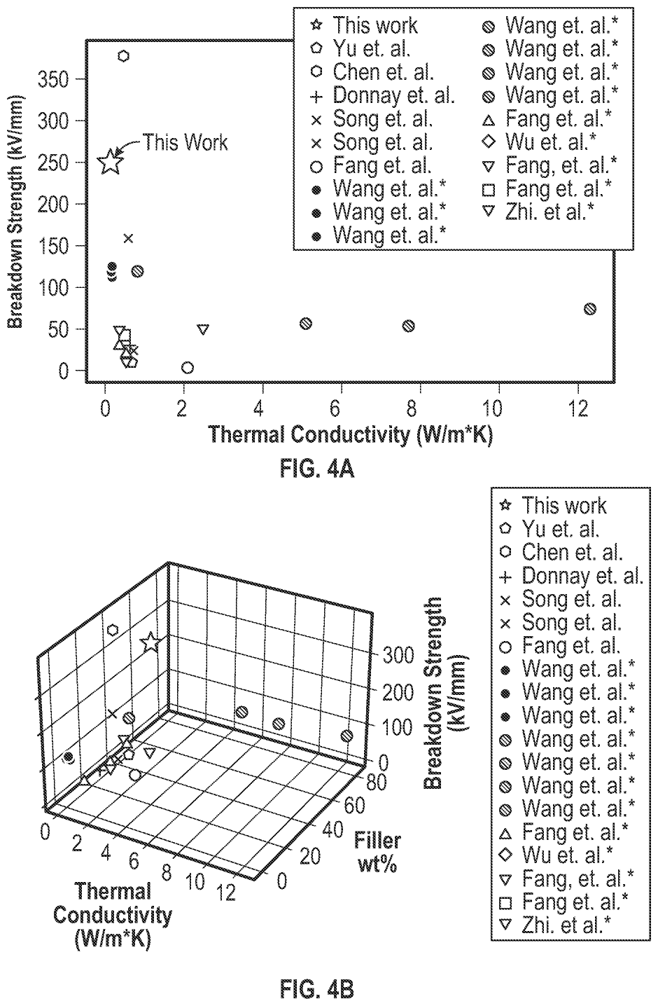

The thermal conductivity, dielectric breakdown strength, and weight percent of filler in the nanocomposite reported herein as well as nanocomposites in literature is presented in FIGS. 4A-B. For references with an asterisk (“*”) in the legend it could not be determined if the thermal conductivity was through-plane or in-plane. The reported nanocomposite demonstrates comparable thermal conductivity and far superior breakdown strength than that of all, but one recently reported nanocomposite by Yu et. Al. displayed in FIGS. 4A-B.

### Dielectric Properties.

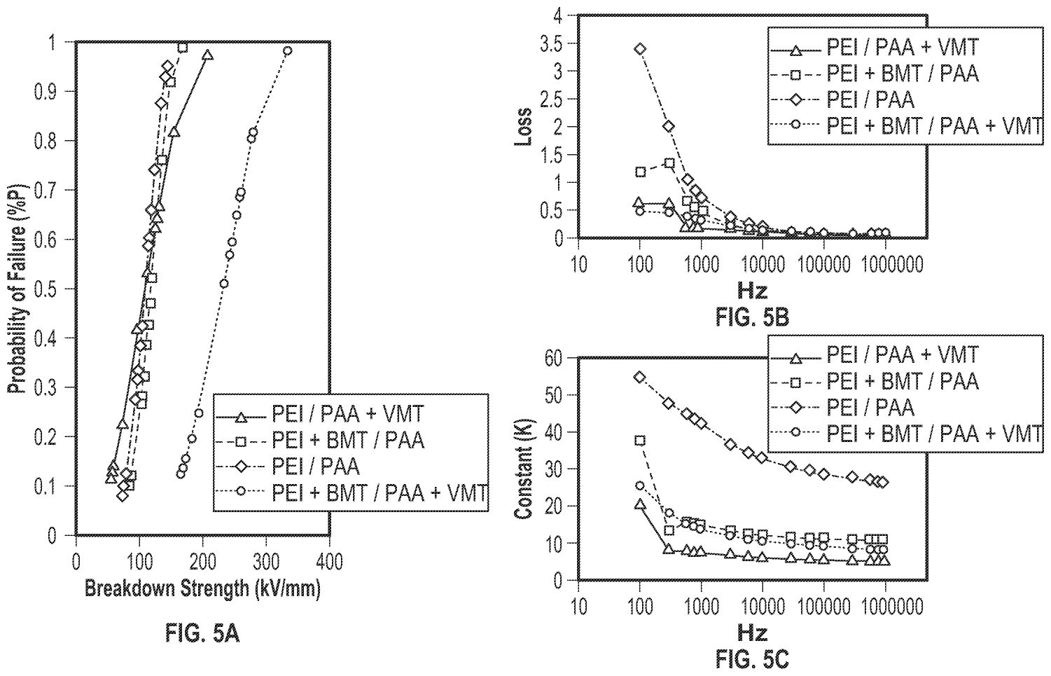

The dielectric properties of the polymer matrix (PEI/PAA), single clay nanocomposites (PEI+BMT/PAA and PEI/PAA+VMT), and the dual clay nanocomposite (PEI+BMT/PAA+VMT) reported herein were investigated at a thickness of approximately 700 nm to minimize property change as a result of thickness variations (i.e., prevent the thickness effect). The dielectric breakdown strength of polymer matrix, single clay systems, and the dual clay system was first investigated. It was determined that PEI/PAA had the lowest breakdown strength (115 kV/mm) followed by the single clay systems which had breakdown strengths of 123 kV/mm (PEI/PAA+VMT) and 125 kV/mm (PEI+BMT/VMT). It is believed that the inclusion of the platelets introduced a tortuous pathway for charge transport and therefore increased the breakdown strength. The dual clay nanocomposite has a nearly 100% increase in breakdown strength (249 kV/mm) when compared to the polymer matrix and single clay nanocomposite, which is believed to be a result of 1) the significantly higher inorganic loading and 2) the effect of a more tortuous pathway for charge transport. Increasing the loading and having a high loading of inorganic material in polymer nanocomposites have been shown to greatly increase breakdown strength. It is important to note that some reports do show that breakdown strength can decrease as inorganic loading increases, however this typically occurs due to preparation techniques of these nanocomposites leading to more defects (i.e., filler aggregation or charge transport pathways) which can negatively impact breakdown strength. The dielectric properties of the analyzed systems are shown in FIGS. 5A-C.

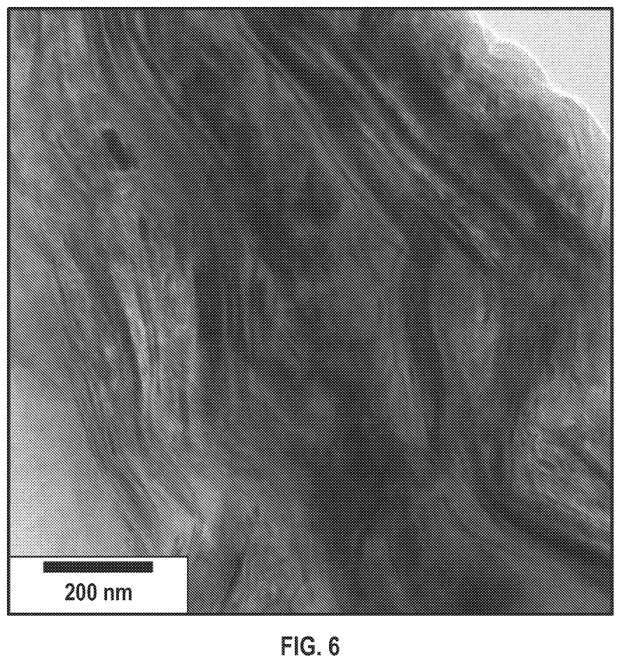

When analyzing the systems' dielectric loss in the frequency regime of 100 Hz to 1 MHz, the PEI/PAA system demonstrates extraordinarily high losses when compared to the other systems. These high losses particularly in the realm of 100-1000 Hz are to be expected of a polyelectrolyte multilayer system and can be attributed to ionic polarization as well as ion transport due to residual amounts of small ions in the film. The dielectric constant of the PEI/PAA system is also particularly high in the 100-1000 Hz region due to ionic polarization as well as small ion transport. After incorporating BMT or VMT independently into the nanocomposite, a significant decrease in the dielectric loss and constant occurs, especially in the realm of 100-1000 Hz. This decrease is believed to be a result of a tortuous pathway blocking small ion transport through the nanocomposite, a similar phenomenon which is exploited in gas barrier and anti-corrosion nanocomposites. Priolo et. Al. reported in their LbL generated nanocomposites that the oxygen transmission rate significantly decreases as the inorganic loading percent increases as a result of the tortuous pathway. It is important to note that the dielectric constant of the PEI/PAA+VMT system is lower than any of the systems presented most likely due to VMT's low degree of polarization and lamellar structure containing large air pockets, both of which have been known to lower dielectric constants of materials. Through incorporating both BMT and VMT into the nanocomposite, the dielectric loss is further decreased likely due to a tortuous pathway for ion transport through the nanocomposite which can be seen in the cross sectional TEM image displayed in FIG. 6. It is also possible that by including the BMT and VMT (independently and together) lower amounts of residual ions are present in the nanocomposite which reduce the dielectric losses in the frequency range of 100-1000 Hz. The dielectric constant of the BMT VMT containing nanocomposite is between the PEI+BMT/PAA and PEI/PAA+VMT nanocomposites dielectric constant across the entire frequency range likely a result of including both BMT and VMT simultaneously.

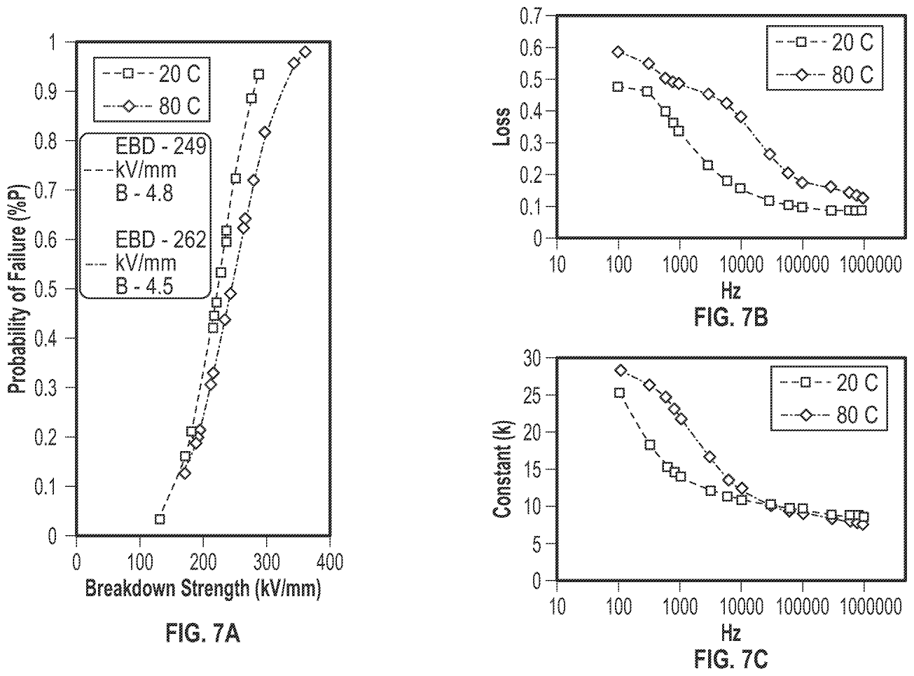

The dielectric properties of the PEI+BMT/PAA+VMT nanocomposite were then investigated at elevated temperatures (80° C.) in order to evaluate how the systems dielectric properties would change at elevated temperatures. It was found that the dielectric constant and dielectric losses increased when the nanocomposite was exposed to elevated temperatures. This was expected due to most dielectric materials' constant and losses increasing due to more energy available for charge transport, ionic polarization, and dipole movement in amorphous materials. The dielectric breakdown strength of the nanocomposite increased from 249 kV/mm to 262 kV/mm as testing temperature also increased. Typically, as temperature increases the dielectric breakdown strength of a material decreases as a result of thermally activated molecular, electronic, and ionic motion in the material. While this likely is occurring in the system presented herein, it is believed that these effects are trumped by the expulsion of molecular water (discussed in the next section). Water is known to negatively impact (i.e., decrease) the breakdown strength of a material through providing ease for ionic and electronic transport. Therefore, by expelling molecular water in the film at elevated temperatures the breakdown strength of the nanocomposite is increased. The dielectric properties of the PEI+BMT/PAA+VMT nanocomposite are presented in FIGS. 7A-C.

### Mechanical Properties.

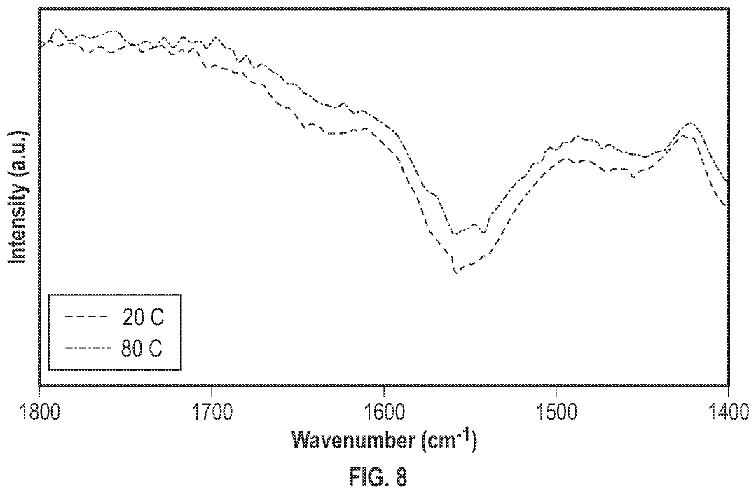

Immediately after elevated temperature dielectric characterization the characterization reported in this section occurred to ensure that minimal environmental moisture returned to the nanocomposite. It has been reported that thermally crosslinking PEI and PAA can increase the breakdown strength of a multilayer thin film. To confirm that the increase in breakdown strength was not a result of crosslinking FT-IR was employed (FIG. 8). It was found that there was no strong peak at 1640 cm⁻¹ (which corresponds to an amide bond) after elevated temperature testing and that a significant decrease or disappearance of a peak at approximately 1540 cm⁻¹ (characteristic peak of PAA's carboxylic acid) also did not occur. Through the lack of amide bond formation and carboxylic acid peak disappearance or reduction in intensity thermal crosslinking was safely ruled out. It should be noted that thermal amidization typically does not rapidly occur (>2 hours) at low temperatures (>130° C.), therefore it is highly unlikely that elevated temperature testing resulted in amidization.

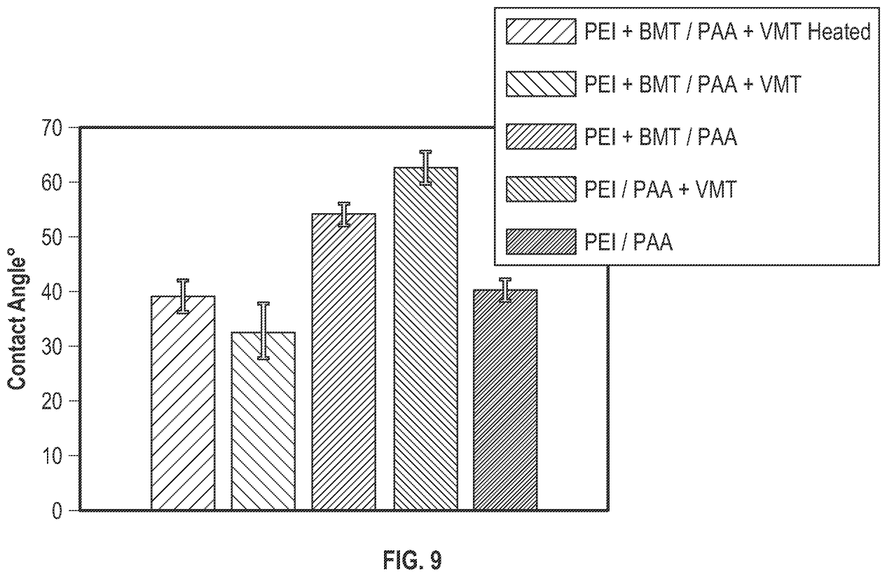

It has been reported that as water content decreases in a polyelectrolyte complex one will observe a decrease in thickness and an increase in modulus. This phenomenon is a result of water's plasticizing role on a polyelectrolyte complex: as the water content increases in a polyelectrolyte complex, the water molecules will plasticize/lubricate complexation sites and therefore decrease modulus. The polyelectrolyte complex will also experience an increase in thickness as water molecules will “swell” complexation sites and therefore increase the thickness of a given film. In order to measure the modulus (Eᵣ) and hardness (H) of the nanocomposites as a function of testing temperature without significant substrate influence, the nanocomposites were grown to a thickness of approximately five microns to ensure the “10% indention rule of thumb” could accurately be employed. It was found that nanocomposites tested at elevated temperatures had an increased modulus from 6.8 to 9.6 GPa and an increased hardness from 0.19 to 0.24 GPa. This increased modulus and hardness are believed to be a result of molecular water expulsion through the elevated temperature testing. Table 3 displays the hardness and modulus of the nanocomposite at 20 and 80° C. Along with increasing modulus and hardness values, the nanocomposites also decrease in thickness after elevated temperature testing by ≈30%. It is imperative to note that after elevated temperature testing all nanocomposites despite starting thickness demonstrated ≈30% reduction in film thickness, a value much lower than that reported for thermal crosslinking. It should be noted that the thickness reduction was dependent on humidity but in all cases film thickness deceased after elevated temperature testing. The nanocomposites water contact angle also increased from 320 to 390 after elevated temperature testing likely due to the removal of the hydration layer at the nanocomposites surface. FIG. 9 displays the water contact angle of the reported nanocomposites and PEI/PAA matrix. The presence of a hydration layer has been found to decrease polyelectrolyte-based film's water contact angle. Through the absence of amide bond formation, a thickness reduction, and an increase in modulus, hardness, and water contact angle it is believed that an increase in dielectric breakdown strength is a result of molecular water expulsion at elevated temperatures. Through decreasing the molecular water content in the nanocomposite the modulus and breakdown strength of the nanocomposite increased. These findings are in good agreeance with Kim and Shi's work which demonstrated that as modulus of a material increased its breakdown strength also increased.

TABLE 3
Hardness and modulus as a function of temperature exposure.

| Temperature (° C.) | H (Gpa) | Er (Gpa) |
|---|---|---|
| 20° C. | 0.19 ± 0.12 | 6.8 ± 3.0 |
| 80° C. | 0.24 ± 0.14 | 9.6 ± 3.4 |

### Nanocomposite Thermal Resilience.

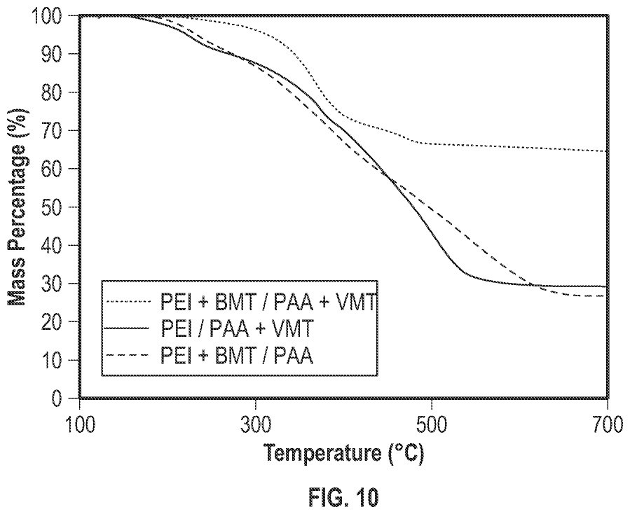

The thermal resilience and inorganic loading weight percent of the nanocomposite was evaluated by subjecting approximately 3.4 mg of the nanocomposite to thermal gravimetric analysis (TGA). The PEI+BMT/PAA+VMT nanocomposite has an inorganic loading of 64 wt % and the PEI+BMT/PAA and PEI/PAA+VMT nanocomposites have an inorganic loading of 27 and 29 wt % respectively. The PEI+BMT/PAA+VMT has a higher inorganic loading due to both the cationic and anionic solutions having inorganic platelets and therefore each deposited layer will have some inorganic components. The degradation temperature is defined as when 5% (T_{d5%}) of the samples weight is lost (excluding mass loss associated with water or solvent evaporation). The PEI+BMT/PAA+VMT nanocomposite has a T_{d5%} of approximately 320° C. This is significantly higher than the Td₅% of the PEI+BMT/PAA and PEI/PAA+VMT nanocomposites which degrade at 230° C. and 220° C., respectively. This significant increase in T_{d5%} can be attributed to the significantly higher inorganic loading in the PEI+BMT/PAA+VMT nanocomposite which has been known to increase the T_{d5%} of a nanocomposite regardless of its thermal conductivity. FIG. 10 illustrates TGA thermographs of mass percentage versus temperature for PEI+BMT/PAA, PEI/PAA+VMT, and PEI+BMT/PAA+VMT nanocomposites.

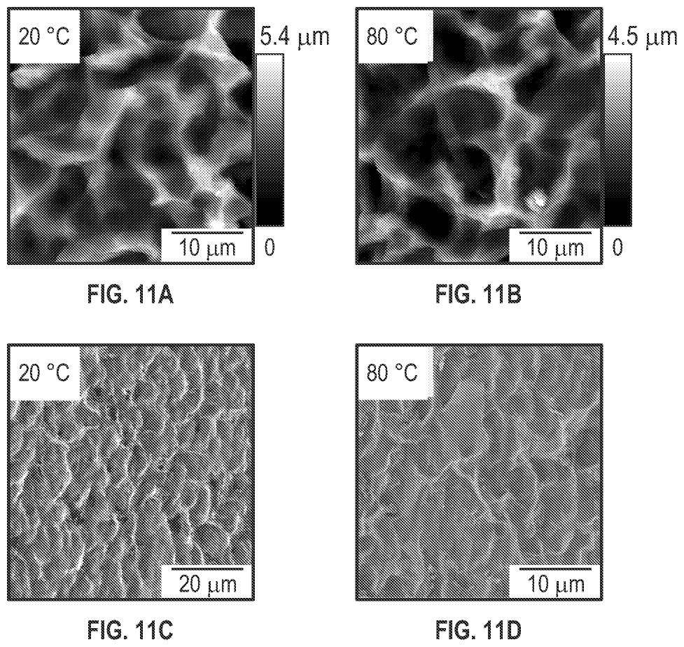

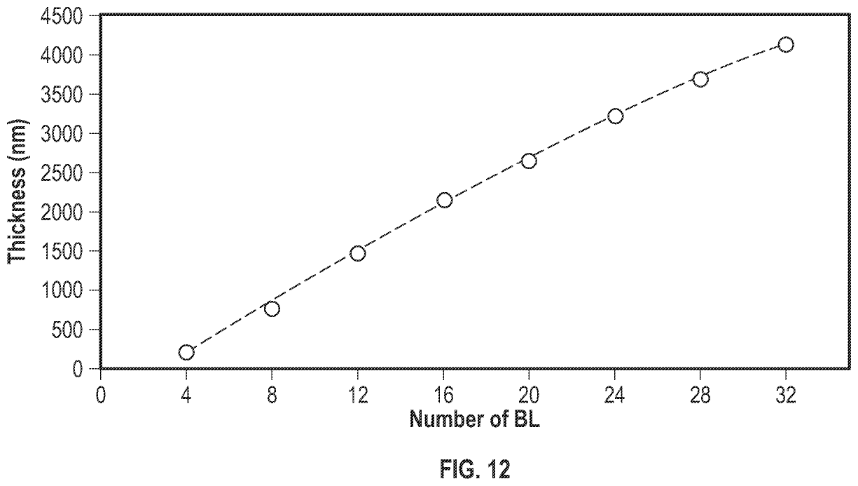

FIG. 11A illustrates an AFM image showing morphology of a nanocomposite before elevated temperature exposure. FIG. 11B illustrates an AFM image showing morphology of the nanocomposite from FIG. 11A after elevated temperature exposure. FIG. 11C illustrates a SEM image showing morphology of a nanocomposite before elevated temperature exposure. FIG. 11D illustrates a SEM image showing morphology of the nanocomposite from FIG. 11C after elevated temperature exposure. FIG. 12 illustrates a growth curve showing thickness versus number of BL for PEI+BMT/PAA+VMT nanocomposite.

### Example 2

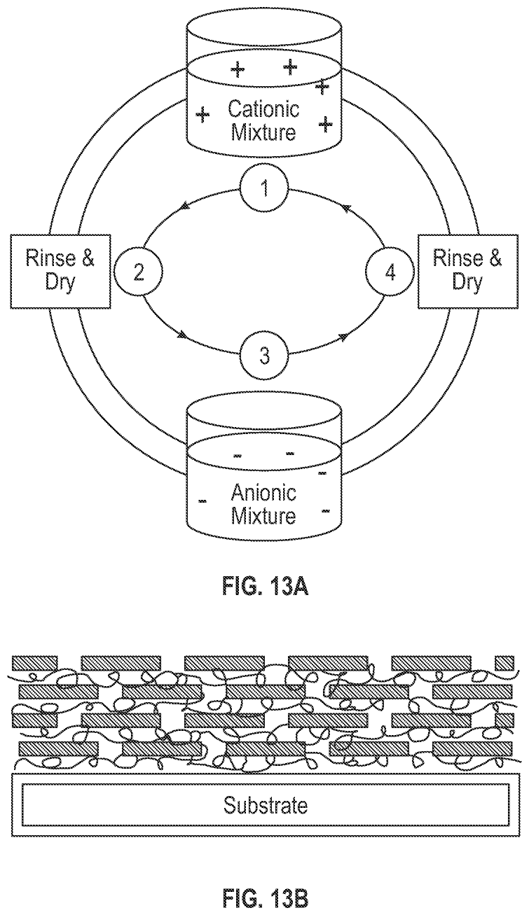

In the proposed work, thin nanocomposite coatings (0.1-5 μm thick) made with polyelectrolytes and/or water-suspendable nanoplatelets (e.g., clays), uniformly applied to suitable substrates, will be developed to impart a unique combination of high voltage and thermal protection. Beneficial properties we observe on initial model substrates (e.g., silicon wafers or glass) are expected to be transferrable to high voltage devices of interest. These thin films, typically <1 μm thick, are created by alternately exposing a substrate to positively- and negatively-charged molecules or particles, as shown in FIG. 13A. Steps 1-4 are continuously repeated until the desired number of “bilayers” (BL) (or cationic-anionic pairs of layers) is achieved. FIG. 13B provides an illustration of a film deposited with a cationic polymer and anionic clay platelets, which is the basis of the proposed project. Individual layers may be 1-100+ nm thick depending on chemistry, molecular weight, temperature, deposition time, and pH of species being deposited. The ability to control coating thickness down to the nm-level, easily insert variable thin layers without altering the process, and process under ambient conditions are some of the key advantages of this deposition technique. In the case of the clay-filled coating shown schematically in FIGS. 13B, these films are also optically transparent. These qualities result in a highly effective, environmentally-friendly coating for reducing thermal penetration and are expected to prevent strike and creep events associated with high voltage devices.

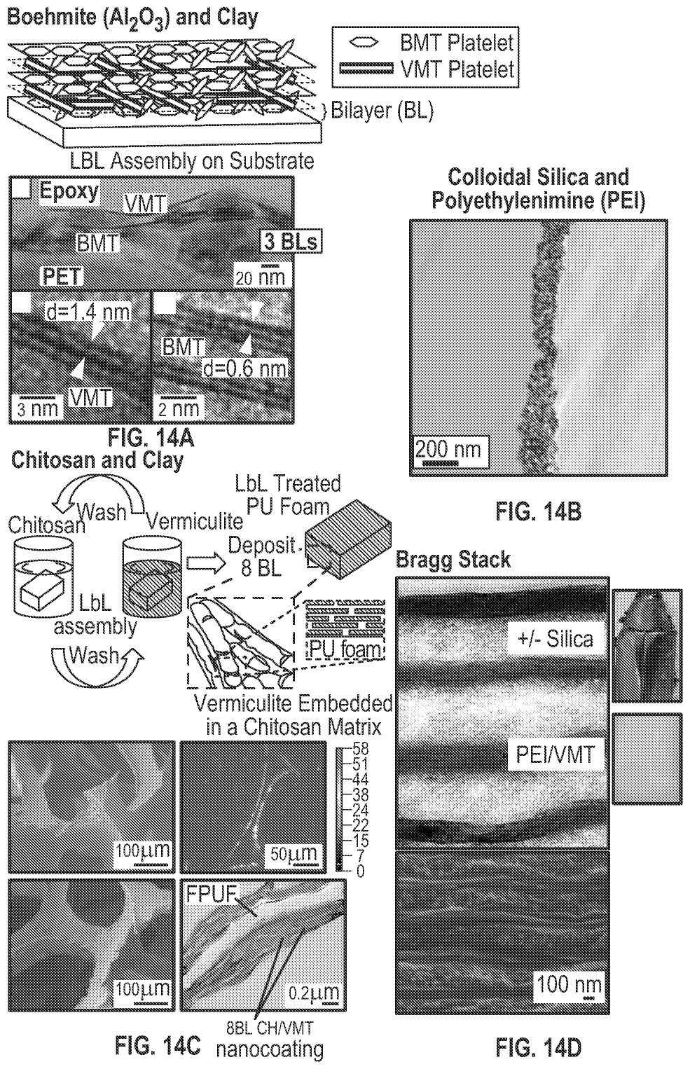

FIGS. 14A-D highlights the breadth of inorganic nanoparticle-based films that can be built using this LbL assembly approach. In an effort to reduce the flammability of polyurethane foam (PUF), a thin film of renewable inorganic nanoparticles (i.e. anionic vermiculite [VMT] and cationic boehmite [BMT]) was deposited on polyurethane foam via layer-by-layer (LbL) assembly (FIG. 14A). 1, 2 and 3 BL of BMT/VMT results in foam with retained shape after being exposed to a butane flame for 10 s, while uncoated foam was completely consumed. Thin films of colloidal silica were deposited on cotton fibers via layer-by-layer (LbL) assembly in an effort to reduce the flammability of cotton fabric. Negatively charged silica nanoparticles of two different sizes (8 and 27 nm) were paired with either positively charged silica (12 nm) or cationic polyethylenimine (PEI) (FIG. 14B). An 8 BL chitosan/vermiculite clay nanocoating on PUF acts as a thermal shield from fire, maintaining the complex three-dimensional porous structure of the foam (FIG. 14C). Layer-by-layer assembly was used to fabricate a synthetic analogue of the color producing multilayered structure commonly found in many biological systems, particularly Coleoptera beetles. The resulting iridescent films include multiple LbL-deposited stripes designed to control color appearance through the materials' refractive indices and individual multilayer stripe thicknesses (FIG. 14D). A temperature gradient greater than 200° C. is observed across a 2.5 cm thick coated foam sample during a rigorous burn-through fire test. We believe LbL nanobrick walls have never been used as protective coatings for high voltage devices. There is a single use of LbL-deposited polyethylenimine and clay for a gate dielectric in a field effect transistor, which provides evidence that this concept will work. We anticipate creating protective films with high in-plane thermal conductivity, low coefficient of thermal expansion, high use temperature (>150° C.) and high breakdown strength. A research plan, involving the design and behavior of LbL assemblies for use as protective nanocoatings is described below.

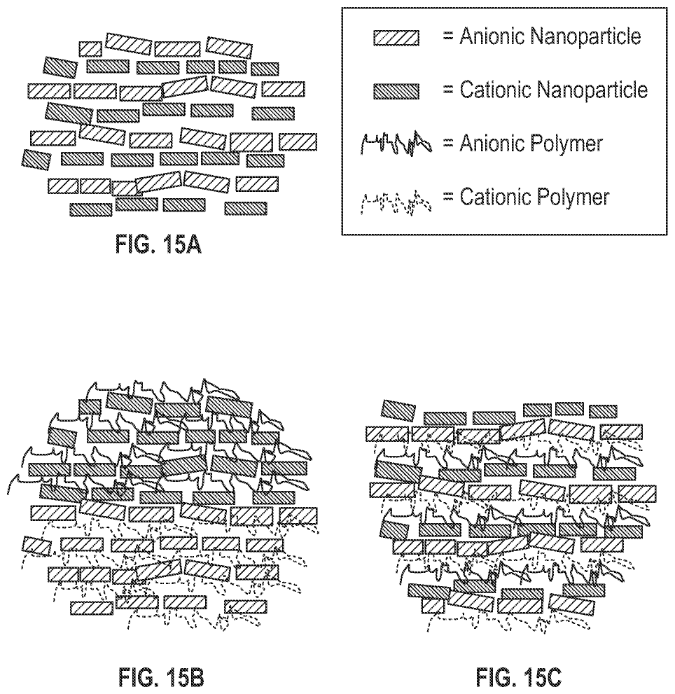

The proposed work will examine the ability of layer-by-layer thin film coatings, made by depositing combinations of polymers and/or nanoplatelets from water, to reduce thermal penetration and to prevent strike and creep events associated with high voltage devices. Each recipe will be characterized from 5-40 bilayers or quadlayers (QL) in 5 (or 10) BL (or QL) increments. As shown in FIGS. 15A-C, we can evaluate a number of layering sequences, with varying combinations of nanoparticles and/or polyelectrolytes, including using positively-charged particles deposited in every other layer and alternating with a negatively-charged particle (15A), using a stack of two different bilayer systems (15B), or various types of quad-layer assemblies can be generating using the technique (15C). Nanoparticle options include various clays (e.g. montmorillonite and vermiculite), boehmite (alumina), hexagonal boron nitride (h-BN), graphene oxide, nanocellulose, and colloidal silica. Montmorrilonite clay can have a dielectric constant of more than 1000 depending on its moisture content, but has a thermal conductivity of less than 2 W/m·K·¹⁵ h-BN is almost the opposite, with a dielectric constant below 7 and thermal conductivity greater than 700 W/m·K. Combining these two materials in a single thin film could be very interesting. Chitosan and polyethylenimine are cationic polyelectrolytes we can use, as needed, while polyacrylic acid and polystyrene sulfonate can serve as polyanions. Silicon wafers and glass slides will serve as the initial model substrates, but we can deposit these protective films on any suitable substrate/device. Films built with polymers will be dense, containing >80 wt % of a given combination of nanoparticles, while completely nanoparticle films will be nanoporous. Dipping and spraying will both be evaluated as a means of treating the substrates. A detailed list of tasks and deliverables is provided in the next sections.

### Project Tasks and Milestones Summary:

Task 1. We will evaluate the coatings shown in FIGS. 15A-C, beginning with montmorrilonite clay (MMT) and hexagonal boron nitride (hBN) as the model nanoplatelets. Polyethylenimine (PEI) and polyacrylic acid (PAA) will be the model cationic and anionic polyelectrolytes, respectively. 10, 20 and 30 bilayers (or quadlayers) can be grown on ARL provided substrates for initial evaluation. These coatings will range in thickness from 100 nm-5 μm and can be deposited conformally onto any substrate of interest. Electron microscopy, ellipsometry, XPS, profilometry, simple gravimetry (i.e., weight gain determination), quartz crystal microbalance (QCM) and atomic force microscopy (AFM) will be used as needed to characterize the growth and microstructure of these multilayer nanocoatings. Thermal stability of the coatings can be evaluated using thermogravimetric analysis (TGA). Adhesion of the nanocoatings will be evaluated using the crosshatch adhesion test (ASTM D 3359).

Task 2. Dielectric constant, thermal conductivity and breakdown strength promising candidate films will be measured.

Task 3. The most promising nanocoatings from Tasks 1 and 2 will be spray coated and their properties compared to their identical dip-coated counterparts. Solution viscosity, spray nozzle geometry, spray pressure, spray time and flow rate will all be studied to achieve the best performing coatings.

Task 4. As our understanding of how film thickness, composition and microstructure develops, the best performing films can be further improved. Additional components can be added to modify nanoparticle alignment, interparticle contacts, etc. For example, salts and buffers can be used to create associations and screen charges, which will alter coating thickness and microstructure.

### Example 3

### Layer-by-Layer Deposition of Thin Films

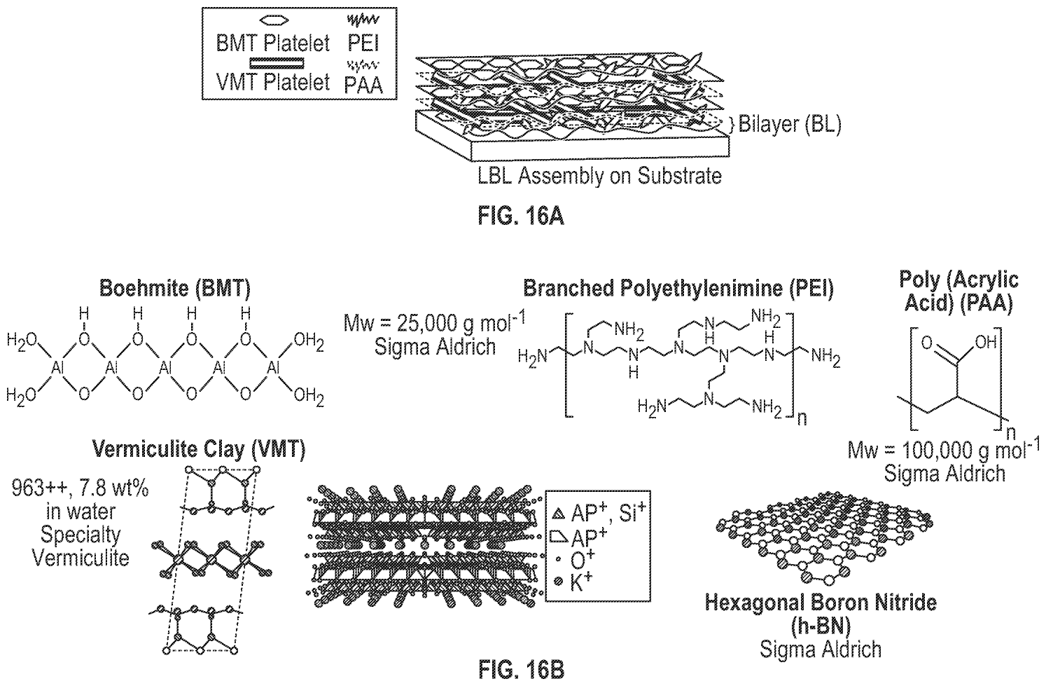

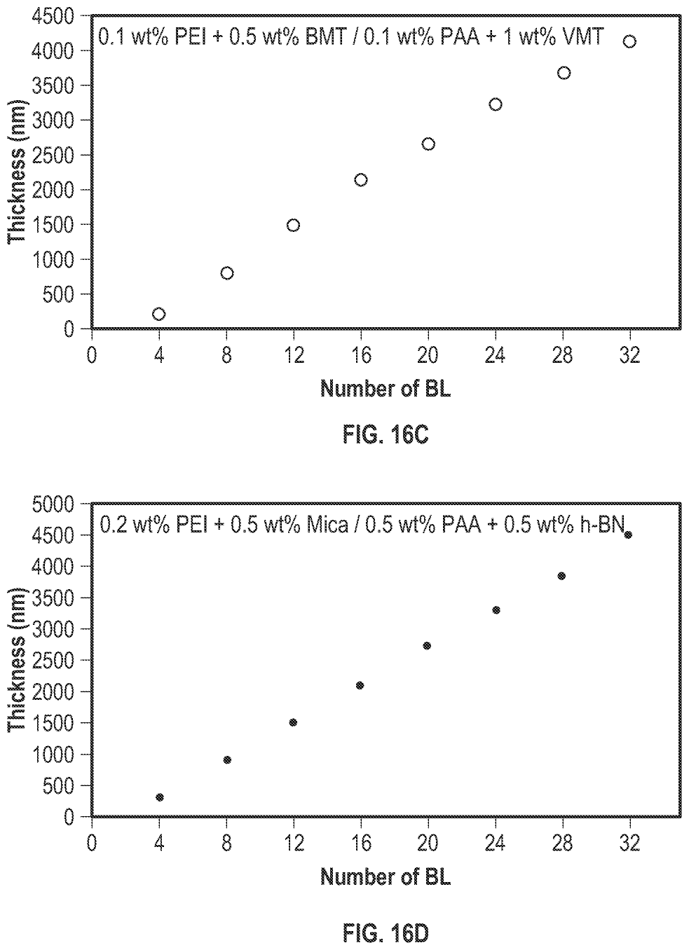

Polymer-based nanocomposites, to be used as thermally conductive coatings and electrical insulators, were prepared using layer-by-layer (LbL) assembly, displayed in FIG. 16A. Benefits of LbL processing include ambient processing, nanoscale control, and versatile properties. By adjusting components (e.g., polyelectrolyte species, solution concentration, fillers, etc.), these films have been demonstrated to have many different functionalities such as gas barrier, thermoelectric, and heat shielding. Superior properties have been found in platelet-based nanocomposites. These films are expected to exhibit high thermal conductivity, as the nanofillers form thermal pathways, reducing thermal resistivity across the film. These films also provide high dielectric breakdown strength through the creation of charge trapping sites and tortuous pathways for charge transport. Thin films, typically between 200 nm to 5 μm thick, are created by alternately exposing a substrate to positively and negatively charged molecules or particles. Deposition steps are repeated until the desired number of “bilayers” (BL), or a certain thickness is achieved. FIG. 16A illustrates a layer-by-layer schematic for a PEI-BMT/PAA-VMT film. FIG. 16B illustrates chemical structures of boehmite (BMT), vermiculite clay (VMT), mica, hexagonal boron nitride (hBN), polyethylenimine (PEI), and poly(acrylic acid) (PAA). FIG. 16C illustrates a growth curve showing thickness versus number of BL for a 0.1% PEI-0.5% BMT/0.1% PAA-1% VMT system. FIG. 16D illustrates a growth curve showing thickness versus number of BL for a 0.2 wt % PEI-0.5 wt % mica/0.5 wt % PAA-0.5 wt % h-BN system.

### Past and Current Objectives

The third quarter focused on improving the BMT/VMT system by incorporating 0.1 wt % PEI into the BMT solution and 0.1 wt % PAA into the VMT solution in hope to improve the thermal conductivity of the nanocomposite by decreasing phonon scattering. These polymers act as “mortar” filling in the gaps between the nanoplatelets. This effort improved the figure of merit to 34-42 kW·MV/m²·K, which is far superior to Kapton HN's figure of merit, 32 kW·MV/m²·K. The fourth quarter focused on improving the thermal conductivity of the nanocomposites by incorporating varying amounts of PEI and PAA into the system, as well as growing 0.1% PEI-0.5% BMT/0.1% PAA-1% VMT to ≈14 μm on copper, the thickness which will insulate well above 2 kV. The thermal conductivity and dielectric breakdown strength were measured for this system, and a figure of merit was calculated. In the fourth quarter, we also established “de-risking” testing parameters for the system which include testing the breakdown strength at elevated temperatures, high levels of film compression, as well as testing in damp/humid environments in the event of water-glycol coolant leakage. In the final quarter of Phase I both windings and “dummy windings” were coated with our high-performance PEI-BMT/PAA-VMT coating for the mottorette testing. This took up a majority of this quarter's timeline. This coating (PEI-BMT/PAA-VMT) provides a breakdown strength of approximately 210-240 kV/mm and a thermal conductivity of 0.16 W/m·K. Modifications to the coating apparatus were applied in order to successfully coat the copper windings and de-risking testing of the insulation was performed. Finally, a new system was developed which has demonstrated a record shattering combination of thermal conductivity and dielectric breakdown strength of 0.86 W/m·K and 108-174 kV/mm, respectively. This system possesses a figure of merit which is approximately a 4× improvement when compared to Kapton HN. The final quarter focused on optimizing the insulation deposition and recoating the windings and “dummy windings” multiple times. Due to this minimal characterization was performed on derisking the insulation (as data collection was critical for establishing Phase II).

In the current quarter, derisking characterization is underway for our older and newest system (PEI-BMT/PAA-VMT and PEI-MICA/PAA-hBN, respectively) by completing a full characterization of the insulation's dielectric properties at various temperatures. It was found that the uncrosslinked PEI-BMT/PAA-VMT insulation exhibited a lower dielectric constant and losses at elevated thicknesses (i.e., more bilayers) and an increased dielectric constant and losses at elevated temperature. When compared to the uncrosslinked PEI-BMT/PAA-VMT insulation, the crosslinked PEI-BMT/PAA-VMT exhibited a lower dielectric constant and lower losses across all frequencies. The uncrosslinked and crosslinked PEI-MICA/PAA-hBN insulation exhibited extraordinary properties; an ultra-low dielectric constant and dielectric losses. This was surprising since the insulation had significantly high thermal conductivity and a lower dielectric breakdown strength (when compared to the PEI-BMT/PAA-VMT insulation). Mechanical characterization was to be conducted on the uncrosslinked and crosslinked PEI-MICA/PAA-hBN insulation, but due to facility construction and instrument closures, this was not performed.

### Materials

Polyethylenimine (PEI) (M_{w}=25,000 g/mol, Mₙ=10,000 g/mol) poly(acrylic acid) (PAA) (M_{w}=250,000 g/mol 35 wt % in water), and hexagonal boron nitride powder (h-BN, 98%, ˜1 μm) were purchased from Sigma-Aldrich (Milwaukee, WI). Boehmite clay (BMT) was purchased from Esprix Technologies (Sarasota, FL) and vermiculite clay (VMT) was purchased from Specialty Vermiculite Corp. (Cambridge, MA). Mica was supplied by LKAB Minerals Inc. (R 120, UK). For the 0.1% PEI-0.5% BMT solution, PEI and BMT were added to distilled (DI) water at 0.1 wt % and 0.5 wt %, respectively. The PEI-BMT solution was then rolled for 24 hours to ensure homogeneous dispersion. Aqueous PAA-VMT containing solutions were prepared at 1 wt % VMT and 0.1 wt % PAA which generated the 0.1% PAA-1% VMT solutions. The solutions were then allowed to roll for 24 hours to generate a homogenous dispersion. PEI and mica were added to DI water at 0.2 wt % and 0.5 wt %, respectively. The resulting 0.2 wt % PEI-0.5 wt % mica solution was rolled for 24 hours to ensure homogeneous dispersion. PAA and h-BN were introduced to DI water at 0.5 wt % respectively and the resulting 0.5 wt % PAA-0.5 wt % h-BN solution was allowed to roll for 24 hours to ensure homogenous dispersion.

### Film Deposition and Pretesting Conditioning

Films for dielectric breakdown testing were prepared on glass slides coated with indium tin oxide (ITO) and thermal conductivity measurements were performed on films coated on undoped silicon wafers. Both ITO glass slides and undoped silicon wafers were purchased from University Wafer (Boston, MA). Substrates were cleaned prior to film deposition by rinsing with DI water followed by a methanol rinse, and then with a final DI water rinse. Substrates were then dried with compressed air and subjected to a 5-minute plasma cleaning utilizing a PDC-32G plasma cleaner (Harrick Plasma; Ithaca, NY). Following the substrates' plasma treatment, thin films were deposited with LbL assembly. For PEI-BMT/PAA-VMT coating deposition, the substrates were dipped into the PEI-BMT solution for 5 minutes followed by a DI water rinse and air-drying and then dipped into the PAA-VMT solution for 5 minutes followed by rinse and dry steps to form the initial BL. Subsequent layers were deposited using 1-minute dip times. All 0.2 wt % PEI-0.5 wt % mica/0.5 wt % PAA-0.5 wt % h-BN films followed an identical process starting with the PEI-mica solution followed by the PAA-h-BN solution.

After film deposition for dielectric measurements, the coated ITO glass slide was allowed to dry in a dry box for 24 hours followed by a second drying step at 70° C. for 1 hour prior to testing. Drying was completed to ensure that no residual water remained in the deposited film. This process is commonly reported in literature to remove residual solvent before breakdown testing. Once drying was completed, the film was subjected to dielectric breakdown testing.

Thickness measurements were performed utilizing an Alpha-SE ellipsometer (J. A. Woollman Co. Inc., Lincoln, NE), equipped with a 632.8 nm laser or a KLA-Tencor P-6 surface profilometer (Malpitas, CA) prior to 3-omega testing and dielectric breakdown testing.

### 3-Omega Thermal Conductivity Measurements

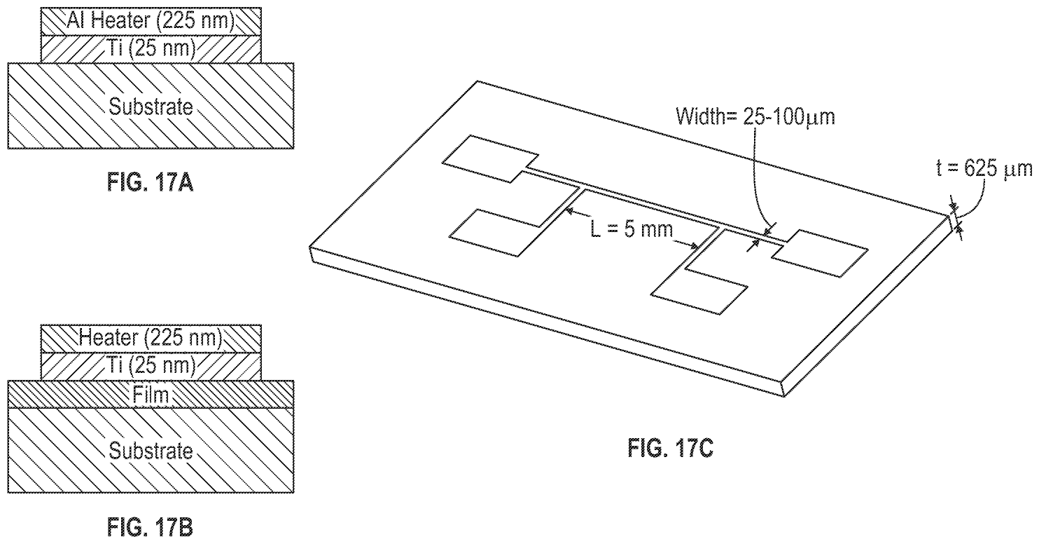

The thermal conductivity (k) of polymer nanocomposite films was measured by the “3-omega” method, using a home-built device. The AC current (I_{ω}) is generated by Keithley 6221 current source. A potentiometer is connected in series to compensate the first harmonic voltage (V_{1ω}) from the sample. The third harmonic voltage (V_{3ω}) is measured by the lock-in amplifier (SR 860). A 5 mm long, 25-100 μm wide, and 225 nm thick Al line in a 4-probe pattern was deposited on top of the nanocomposite film-substrate using the shadow mask and e-beam deposition technique. In order to improve adhesion, an additional 25 nm titanium (Ti) layer was deposited between the heater and the film. The sample geometry is shown in FIGS. 17A-C.

The thermal conductivity of the underlying silicon substrate was measured separately, and its value, 146.51 W/m/K, used to calculate the temperature amplitude of heater oscillation. The amplitude of temperature oscillation of the heater line on top of substrate in the 3-omega method is given by the relation,

$$Δ T = \frac{2 {V}_{3 ω}}{β {V}_{1 W}}$$

where, V_{3ω} and V_{1ω} is the amplitude of the third and first harmonic voltage, and

$$β ( = \frac{1}{{R}_{o}} \frac{dR}{dT} )$$

is the temperature coefficient of resistance of heater/sensor.

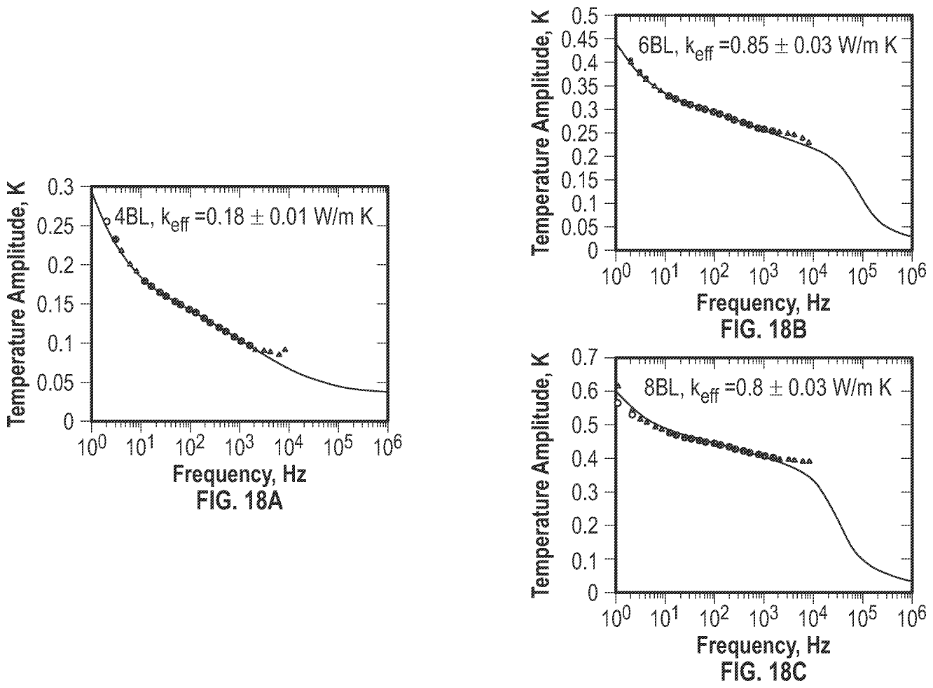

In the presence of the film, the temperature amplitude of heater oscillation is obtained by, ΔT=T_{substrate+film}−T_{substrate}. The temperature amplitude (in-phase) oscillations of the heater line as a function of current frequency for 4, 6, and 8 BL of 0.2 wt % PEI-0.5 wt % mica/0.5 wt % PAA-0.5 wt % h-BN nanocomposite film is shown in FIGS. 18A-C (the solid line is the theoretical model, solid dots are the measured values and red open circles are fitted data points to the model). The corresponding thermal conductivity values are also shown (k).

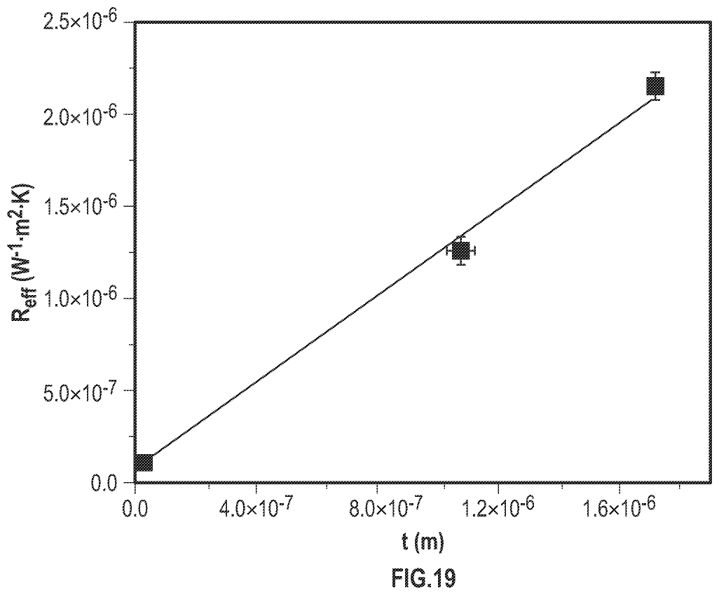

From the aforementioned thickness series' thermal conductivity values, the effective thermal conductivity can be found of the tested material. This is done by graphing the thickness as a function of the heater resistance at those respective thicknesses (FIG. 19). From this graph the effective heater resistance (the slope) of the material can be obtained, this value can then be utilized to calculate the effective thermal conductivity of the material, k_{eff}. The k_{eff} of the system was found to be 0.86 W m⁻¹K⁻¹ which has been the highest reported thermal conductivity so far for these types of nanocomposite films.

### Dielectric Property Measurements.

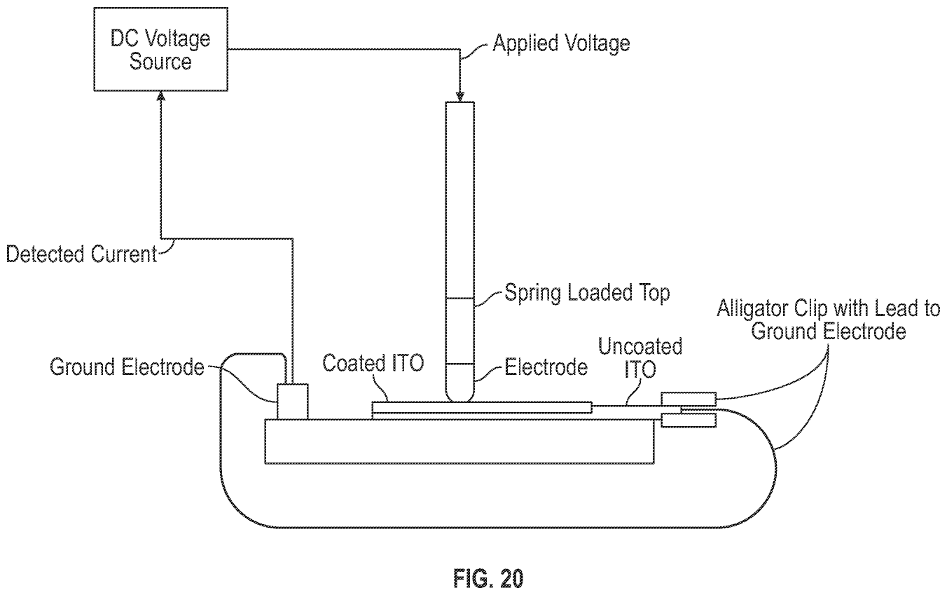

The dielectric breakdown strength of a material is defined as the amount of voltage that can be applied to a material which results in a breakdown event. The breakdown strength of polymer and clay nanocomposite films was measured utilizing a SCI 290 Series Hipot Tester as a DC voltage source equipped with a PolyK test fixture for high voltage dielectric breakdown testing (FIG. 20). Voltage was applied through the top electrode and was detected through an alligator clip attached to a portion of the uncoated ITO substrate. Once a breakdown event occurred, the voltage and current were sent back to the DC voltage source signaling the film's breakdown.

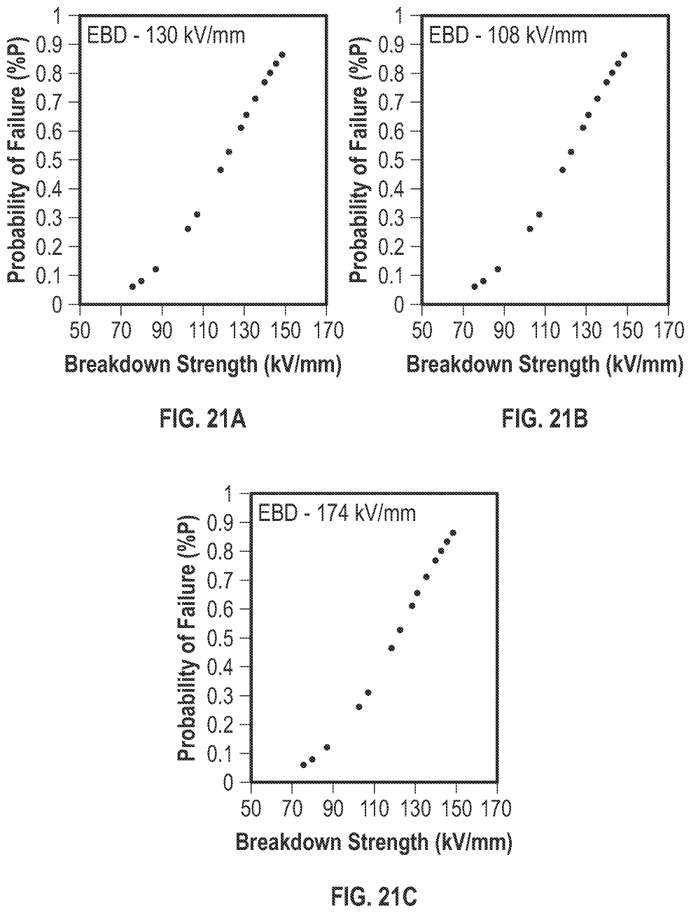

Film breakdown testing was conducted utilizing the dielectric strength ASTM-D149 short-time method. The short-time method states that voltage will be applied across two electrodes and rises from zero at a uniform rate to the breakdown voltage of a material. A breakdown event is defined as when a 5.00 mA or greater current was detected through the two electrodes. Fifteen breakdown events were measured and recorded to conduct a Weibull probability of failure analysis. The Weibull probability of failure analysis reports the probability that the insulating material will break down. A two-parameter Weibull cumulative probability function was utilized to fit the fifteen breakdown events and is given by,

$$P ( E ) = 1 - exp [ - {( \frac{E}{EBD} )}^{β} ] ,$$

where PI is the cumulative probability of failure, E is the experimental breakdown point, EBD is the dielectric breakdown at 63.2% of the max PI value, and β is the shape parameter that is associated with the least-squares fit of the dielectric breakdown data distribution. Data from this function for the tested films is presented in FIGS. 21A-C (each dot represents a breakdown event which was used to perform a Weibull probability of failure analysis).

A dielectric constant is broadly defined as the extent at which a material will be polarized by an applied electric field (the higher the polarization the higher the k). Dielectric loss is the energy that is lost typically in the form of heat by a material when the material is subjected to an electric field. Broadly speaking, a material's dielectric loss is highest when the resonance frequency of a dipole is near or equal to the oscillation frequency of the applied electric field. When this occurs, a delay in polarization occurs, ultimately resulting in an interaction between the dielectric and the electric field which results in heating. The dielectric constant and loss were measured utilized a custom setup with a Keysight E4980AL Precision LCR Meter with two kelvin clips. One clip was placed on the ITO substrate and the other was attached to a needle which was inserted into a ball of a gallium-indium compound which acted as a top electrode on the insulation. The diameter of the electrode was determined utilizing a high-resolution camera, Fly Capture program, and ImageJ. A frequency sweep from 20 Hz to 1 MHz was conducted and the dielectric constant and loss was calculated. To characterize the dielectric constant and loss at elevated temperature, the setup was placed on a hotplate. A figure of merit, that combines the thermal conductivity and breakdown strength of Kapton HN, has been established as a comparison value. This figure of merit (32 kW·MV/m²K) allows for easy comparison of the overall performance of the tested systems. Table 4 below details all the measured values and corresponding figure of merit where applicable.

TABLE 4
Thickness, thermal conductivity, and dielectric properties
of uncrosslinked nanocomposite films and Kapton HN.

| | | | | | |
|---|---|---|---|---|---|
| | | | Thermal | | |
| Film | Dielectric | Dielectric Constant | Conductivity | Dielectric | |
| Thickness | Loss | (k) | (k) | Breakdown | Figure of Merit |
| (nm) | @ 1 kHz | @ 1 kHz | (W/m/K) | (kV/mm) | (kW · MV/m² · K) |

0.1% PEI-0.5% BMT/0.1% PAA-1% VMT

| | | | | | |
|---|---|---|---|---|---|
| 198 | NA | NA | 0.52 | 210 | 109.2 |
| 711 | 0.3 | 13.8 | 0.30 | 249 | 74.7 |
| 1080 | NA | NA | 0.19 | 240 | 45.6 |
| 1607 | NA | NA | NA | 235 | — |
| | | Effective Thermal | 0.16 | 210-265 | 33.6-42.4 |
| | | Conductivity | | | |

0.2 wt % PEI-0.5 wt % mica/0.5 wt % PAA-0.5 wt % h-BN

| | | | | | |
|---|---|---|---|---|---|
| 263 | NA | NA | 0.18 | 130 | 23.4 |
| 967 | NA | NA | 0.85 | 108 | 91.8 |
| 1660 | NA | NA | 0.80 | 174 | 139.2 |
| 2200 | 0.1 | 3.2 | NA | 176 | |
| | | Effective Thermal | 0.86 | 108-174 | 92.9-149.6 |
| | | Conductivity | | | |

Kapton HN

| | | | | | |
|---|---|---|---|---|---|
| NA | 0.0016 | 3.4 | 0.13 | 268 | 32 |

(NA)* Films were too rough to obtain thermal conductivity measurements via 3-omega measurements or only one thickness was measured for dielectric constant and loss measurements.

Per the past quarters, it was found that decreasing both the PEI and PAA concentrations in the PEI-BMT/PAA-VMT systems led to a decrease in the breakdown strength of the film and an increase in thermal conductivity. It is believed that lower polymer concentrations led to less polymer-polymer interactions, and more polymer-nanoplatelet interactions. Due to this, the thermal conductivity was enhanced through reduced phonon scattering at the platelet interfaces and due to less polymer in the film itself. It is hypothesized that the decreased breakdown strength is due to a large difference between the conductive properties of the filler and the polymer matrix. Therefore, less polymer-nanoplatelet interactions will produce a higher breakdown strength, but at the cost of a lower effective thermal conductivity (and visa-versa). However, when comparing both studied systems (0.1 wt % polymer and 0.05 wt % polymer systems) to the state-of-the-art Kapton, their performance meets and exceeds Kapton's performance.

Furthermore, last quarter, an impressive 0.86 W/m·K was obtained utilizing mica and h-BN as the nanoplatelet fillers. It is believed that a through plane “thermal highway” was created in the film due to the platelets connecting/overlapping with one another. This effectively allowed for the heat to travel through the film with minimum phonon scattering. It is speculated that due to the large aspect ratio/size of both platelets, the platelets exhibit a higher degree of alignment when compared to the BMT VMT containing systems, which allows for a higher thermal conductivity of the system overall. The mica clay and hBN also exhibit a much higher thermal conductivity when compared to VMT.

This quarter, the dielectric loss and constant were obtained for the PEI-BMT/PAA-VMT and PEI-MICA/PAA-hBN systems. It was found that the PEI-BMT/PAA-VMT system displayed high dielectric loss and constant at 1 KHz (0.3 and 13.8, respectively). 1 KHz data was chosen for reporting values as reporting at this frequency is commonly done in literature. The high dielectric constant and is likely due to the inclusion of BMT as it has a high dielectric constant (20.5). This high dielectric constant could also be due to the high degree of polarity (polar bonds/polar interactions) within the insulation. The high losses can be attributed to 1) chain movement of the polymers under the applied electric field and 2) a consequence of the materials high dielectric constant as there is typically a positive correlation between dielectric constant and loss. The nanocomposite was then grown out to a thicker thickness (30 BL) to see how thickness affects dielectric constant and losses. It was determined that both the dielectric loss and constant of the material decrease as the thickness increases. The dielectric constant and loss at higher thickness was 4.35 and 0.08, respectively. This decrease in dielectric constant and loss as thickness increases is a commonly reported phenomenon. This data was promising as lower dielectric constant and losses are more desirable for insulation systems (i.e., it extends its lifetime). The crosslinked PEI-BMT/PAA-VMT system (which is not tabulated in this report) showed an impressive reduction in its dielectric constant and loss (6 and 0.16, respectively) when compared to the uncrosslinked system. This was to be expected as crosslinking can result in a reduction in free volume and chain movement (both of which can result in higher dielectric constants and losses).

As shown in Table 5, the PEI-MICA/PAA-hBN system had an impressive dielectric constant of 3.2 and low dielectric loss of 0.1 at 1 KHz. It is believed that this can be attributed to 1) the low clay loading (approximately 20 wt %) and 2) the properties of mica and hBN. It has been reported that lower inorganic loading can result in lower dielectric constant values as the nanocomposite will reflect the dielectric constant of the polymer matrix. Both mica and hBN have low dielectric constants and dielectric losses (for a clay) across a broad frequency range. Their inclusion in the system is believed to create charge trapping sites which reduce the polarization (dielectric constant) and dielectric losses. The crosslinked PEI-MICA/PAA-hBN (not tabulated here) also had an impressive dielectric constant (1.6) and a dielectric loss (0.02) at 1 KHz. This further reduction (improvement) in dielectric properties is due to thermal crosslinking reducing chain movement.

The performance of the PEI-BMT/PAA-VMT system was then evaluated at elevated temperatures. A temperature of 80° C. was first tested due to limitations of the testing setup. Future efforts will look to analyze the dielectric performance of the material at temperatures near that of motor operation. It was found that both dielectric constant and dielectric loss of the material increased. The increase in both dielectric loss and dielectric constant at elevated temperatures is due to more energy available for chain and charge carrier movement which is a well-documented phenomenon. An increase in dielectric constant and loss for the crosslinked system also was observed, but this increase was much more minimal, and the values did not surpass that of the uncrosslinked system at room temperature. The results are shown in Table 5.

TABLE 5
Measured thickness, dielectric breakdown, dielectric
constant, dielectric loss, modulus, and hardness of
nanocomposite films at different testing temperatures.

| | | | | | |
|---|---|---|---|---|---|
| | Testing | | | | |
| Film | Temper- | | Dielectric | | |
| Thickness | ature | Modulus | Breakdown | Dielectric | Dielectric |
| (nm) | (° C.) | (Gpa) | (kV/mm) | Constant | Loss |

0.1% PEI-0.5% BMT/0.1% PAA-1% VMT

| | | | | | |
|---|---|---|---|---|---|
| 736 | RT | 6.78 | 234 | 13.8 | 0.3 |
| 484 | 80 | 9.55 | 262 | 21.6 | 0.5 |

0.2% PEI-0.5% mica/0.5% PAA-0.5% h-BN

| | | | | | |
|---|---|---|---|---|---|
| 12000 | RT | TBD | 90 | 3.2 | 0.1 |
| 12863 | 80 | TBD | 70 | TBD | TBD |

For the PEI-MICA/PAA-hBN it is important to note that the breakdown strength at RT is much lower than the breakdown strengths displayed in Table 4. This is due to the “thickness effect” which states that as thickness is increased breakdown strength decreases due to an increase in the presences of inhomogeneities in the insulation. For the PEI-BMT/PAA-VMT system, as testing temperature increases (above 70° C.), a decrease in thickness and an increase in modulus and hardness is observed. These changes to the films properties are a result of thermal crosslinking between PEI and PAA as well as the expulsion of molecular water. At higher temperatures (180-200° C.) thermal crosslinking will be the driving factor for these changes. At lower temperatures >70° C., the expulsion of molecular water will cause these changes as water can be detrimental to dielectric materials. In short, crosslinking results in a decrease in chain mobility while under an applied electric field. Crosslinking also decreases free volume, a change which helps increase breakdown strength. Free volume is catastrophic to the insulation, as it allows electrons to be accelerated throughout the film under an applied electric field.

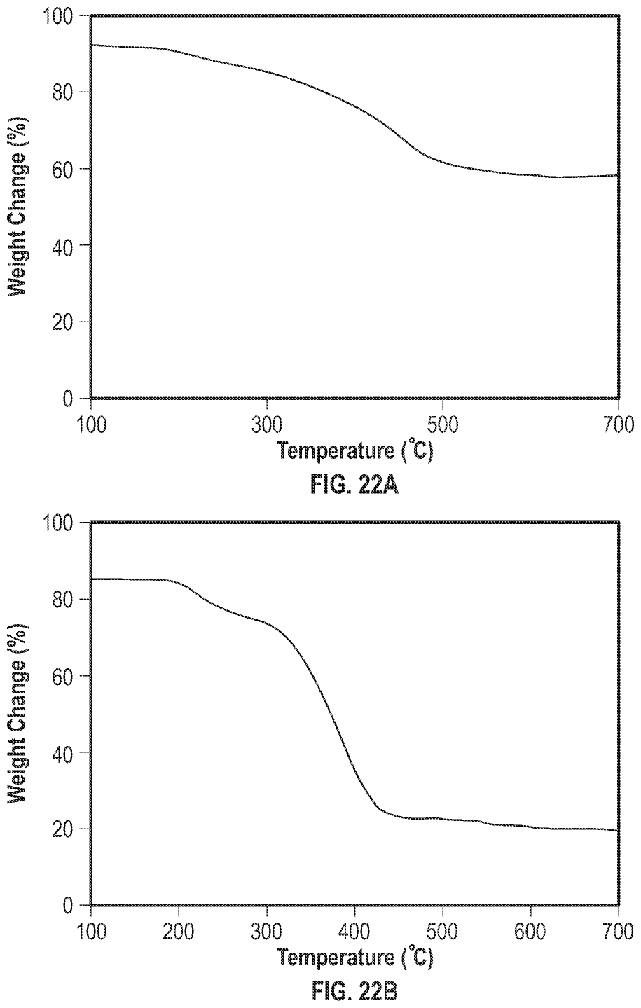

Additionally, thermogravimetric analysis (TGA) was conducted on this insulation and it was determined that around 100° C. molecular water is expelled from the film. It was also determined that (by weight percent) approximately 10 weight percent of molecular water is expelled from the insulation. FIG. 22A shows the TGA graph. This expulsion of water in combination with the thermal crosslinking allows for the 0.1% PEI-0.5% BMT/0.1% PAA-1% VMT system to increase its breakdown strength as a function of temperature. When analyzing the PEI-MICA/PAA-hBN system, it was determined that around 100° C. molecular water is expelled from the film. It was also determined that (by weight percent) approximately 10 weight percent of molecular water is expelled from the insulation. FIG. 22B shows the TGA graph. It can be seen that the PEI-MICA/PAA-hBN system has a lower degradation temperature (230° C.) when compared to the PEI-BMT/PAA-VMT system (250° C.) which is likely because it has a lower clay loading content. It is believed that this will not be an issue due to its significantly higher thermal conductivity. With a higher thermal conductivity, it is believed the winding hot spots will be a significantly lower temperature. When analyzing the 0.2 wt % PEI-0.5 wt % mica/0.5 wt % PAA-0.5 wt % h-BN system, it appears as though elevated temperatures negatively impact the breakdown strength. This does not come at a surprise as most polymeric materials typically show a negative correlation with breakdown strength as a function of temperature. While the modulus and hardness of this insulation have not been recorded yet due to instrumental and facility closures, it is suspected that both quantities will increase as a result of testing temperature inducing amidization and evaporation of water.

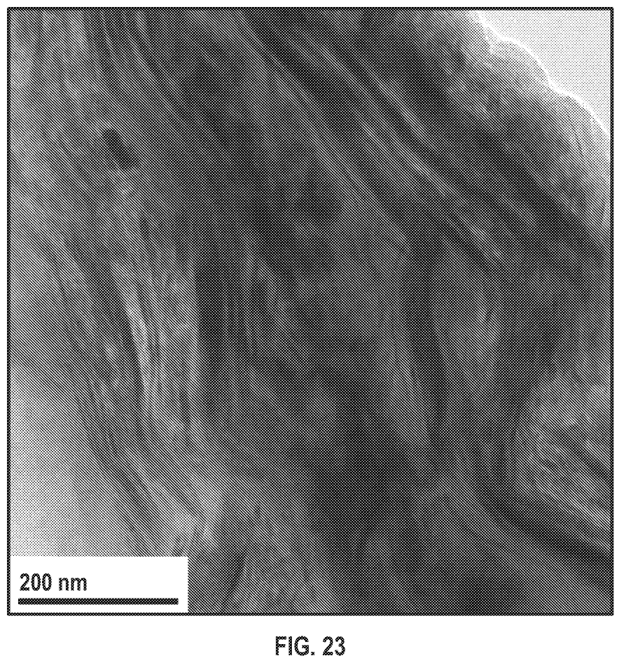

Finally, the PEI-BMT/PAA-VMT system had its morphology analyzed via transmission electron microscopy (TEM). Our hypothesis that a “nanobrick wall” was developed with this recipe which helped produce our impressive thermal transport and dielectric properties. Inspecting FIG. 23, it can be seen that a severe tortuous path is created for charge carriers to transverse through. This same path helps the transport of phonons throughout the film, which is why our nanocomposite has an elevated TC when compared to most amorphous polymer matrixes which typically have a TC between 0.05-0.1 W/m*K. Future efforts will focus on imaging the PEI-MICA/PAA-hBN system to determine how its microstructure relates to its function.

### Conclusions and Next Steps

As previously noted, the 0.1% PEI-0.5% BMT/0.1% PAA-1% VMT films generated a superior figure of merit (34-42 kW·MV/m²·K) when compared to Kapton HN (32 kW·MV/m²·K) and demonstrated impressive elevated temperature performance. The 0.2 wt % PEI-0.5 wt % mica/0.5 wt % PAA-0.5 wt % h-BN system generated an impressive 0.86 W/m·K thermal conductivity and a breakdown strength ranging from 108-174 kV/mm, bringing the figure of merit range to 92.9-149.6 kW·MV/m²·K. It is believed that a through plane “thermal highway” is created with this new system, allowing for a higher thermal conductivity value. This “thermal highway” is believed to be generated to a higher degree than the BMT VMT system, which is why there is such a large improvement in thermal conductivity. Also both fillers in this new recipe innately have a higher thermal conductivity. This 4-5× improvement over Kapton HN is truly remarkable.

The dielectric constant and loss of both insulation systems was analyzed at room temperature. It was found that the dielectric constant and loss were particularly high (6.78 and 0.3) and that elevated temperatures seemed to increase the dielectric constant and losses (9.55 and 0.5). While this increase in dielectric constant and loss is not ideal (due to increased risk of lifetime failure), the dielectric constant and loss are greatly reduced at higher thicknesses, suggesting that the insulation will have a lower dielectric constant and loss when coated onto the windings (due to it being thicker). It was determined that the crosslinked PEI-BMT/PAA-VMT system (which is not tabulated in this report) showed an impressive reduction in its dielectric constant and loss (6 and 0.16, respectively) when compared to the uncrosslinked system. This was to be expected as crosslinking can result in a reduction in free volume and chain movement (both of which can result in higher dielectric constants and losses). Future efforts will look at “lifetime characterization” of the insulation under extreme conditions for commercialization purposes. Dielectric performance at reduced temperature (−50° C.) will also be investigated. It is likely that this lifetime characterization would not be completed by the time a motor prototype would need to be built. Therefore, a commercially available insulation will likely be implemented onto the motor prototype.

With respect to the PEI-MICA/PAA-hBN system, this system had an impressive dielectric constant of 3.2 and low dielectric loss of 0.1 at 1 KHz. It is believed that this can be attributed to 1) the low clay loading (approximately 20 wt %) and 2) the properties of mica and hBN. Thermal crosslinking the system further reduced the dielectric constant and loss to 1.6 and 0.02, respectively. Future efforts will look at elevated temperature dielectric and mechanical testing in order to “derisk” the insulation by understanding its performance at elevated temperature. Dielectric performance at reduced temperature (−50° C.) will also be investigated. Again, future efforts will look at “lifetime characterization” of the insulation under extreme conditions for commercialization purposes. It is likely that this would not be completed by the time a motor prototype would need to be built. Therefore, a commercially available insulation will likely be implemented onto the motor prototype.

If both analyzed insulations fail to meet performance expectations during lifetime testing, a sandwich structure will be investigated similar to TKT which will help decrease the moisture content in the insulation, thereby increasing the lifespan of the film and the properties. Due to all of the reported insulation recipes' superior properties when compared to Kapton, it is expected that our insulations “sandwiched” performance will greatly outperform the performance of TKT. We are hopeful that we can pair with a company partner who can assist us in producing this layered insulation and lifetime testing.

Finally, future efforts (as always) will also focus on developing better combinations of thermal conductivity and dielectric breakdown strength. A new insulation in development will combine PEI, graphene, PAA, and hBN; an insulation expected to perform better than the PEI-MICA/PAA-hBN system. This is because it will be filled with two high thermally conductive fillers (graphene has a higher TC than mica clay). It is believed that a thermal conductivity of 1 W/m·K and a breakdown strength that exceeds 200 kV/mm can/will be obtained in the near future, which will be a significant contribution to the field of insulations for extreme conditions.

### Example 4. PEI-MICA/PAA-hBN

The samples had bilayers of 0.2 wt % PEI+0.5 wt % Mica/0.5 wt % PAA+0.5 wt % hBN. The properties are shown in Tables 6-7.

TABLE 6
Properties for 0.2 wt % PEI + 0.5 wt % mica/0.5
wt % PAA + 0.5 wt % h-BN.

| | | Thermal | |
|---|---|---|---|
| | Film | conductivity (k) | Dielectric |
| BL | thickness (nm) | (W/m/K) | breakdown (kV/mm) |
| 4 | 263 | 0.18 | 140 |
| 6 | 967 | 0.85 | 131 |
| 8 | 1660 | 0.8 | 172 |
| | keff | 0.86 | 131 |

TABLE 7

| | | |
|---|---|---|
| | Through plane thermal | Dielectric |
| Sample | conductivity | constant |

| | | | |
|---|---|---|---|
| Conventional covalent | 1-0.89 | W/m*K | 1.62 |
| organic frameworks (COFs) | | | |
| Our system crosslinked | 0.86 | W/m*K | 1-1.5 |

To our knowledge, the system had the highest recorded effective thermal conductivity to date of a LbL-generated system. The system had Figure of Merit of 129 kW·MV/m²·K. Kapton HN has Figure of Merit of 18-36 kW·MV/m²·K.

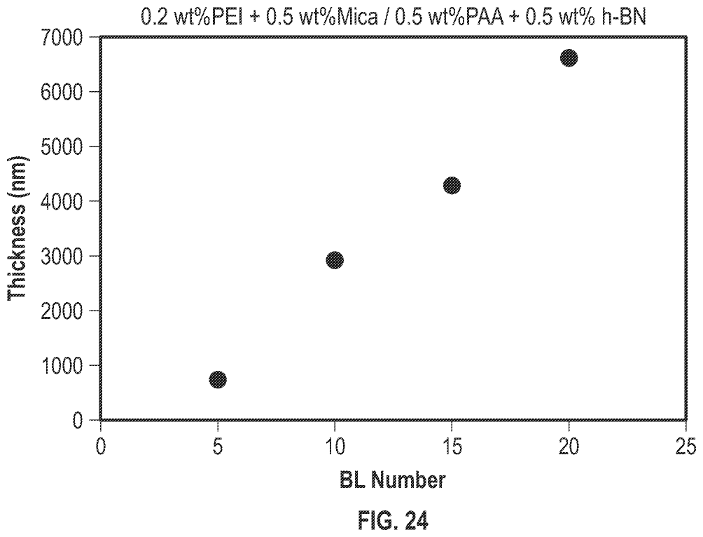

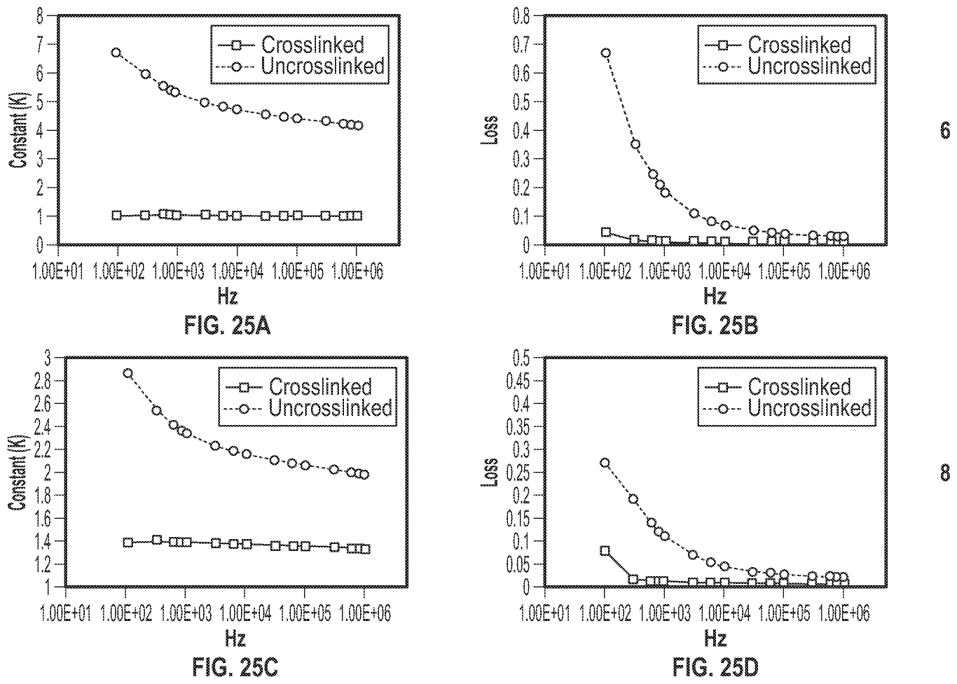

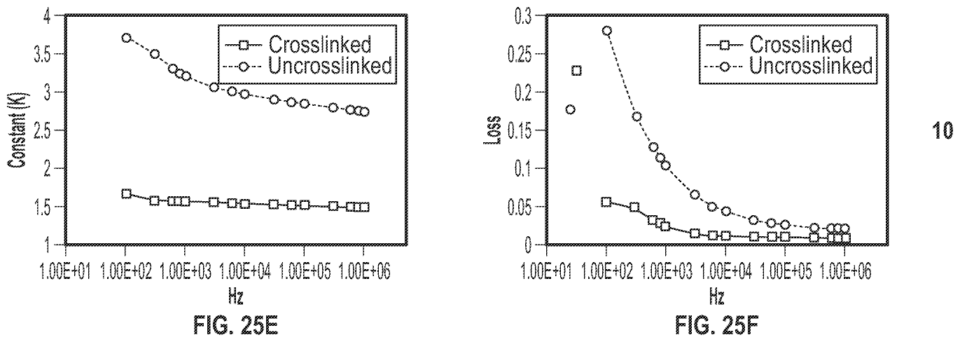

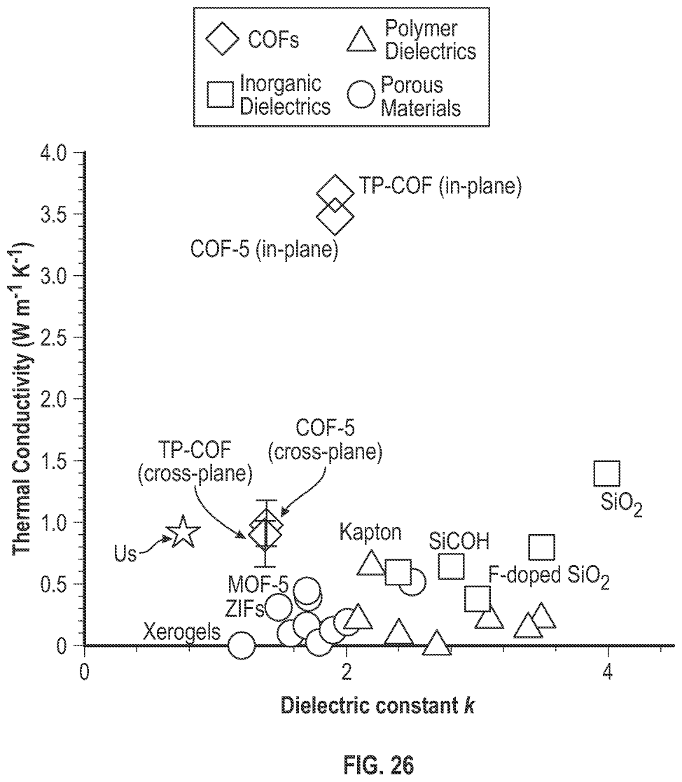

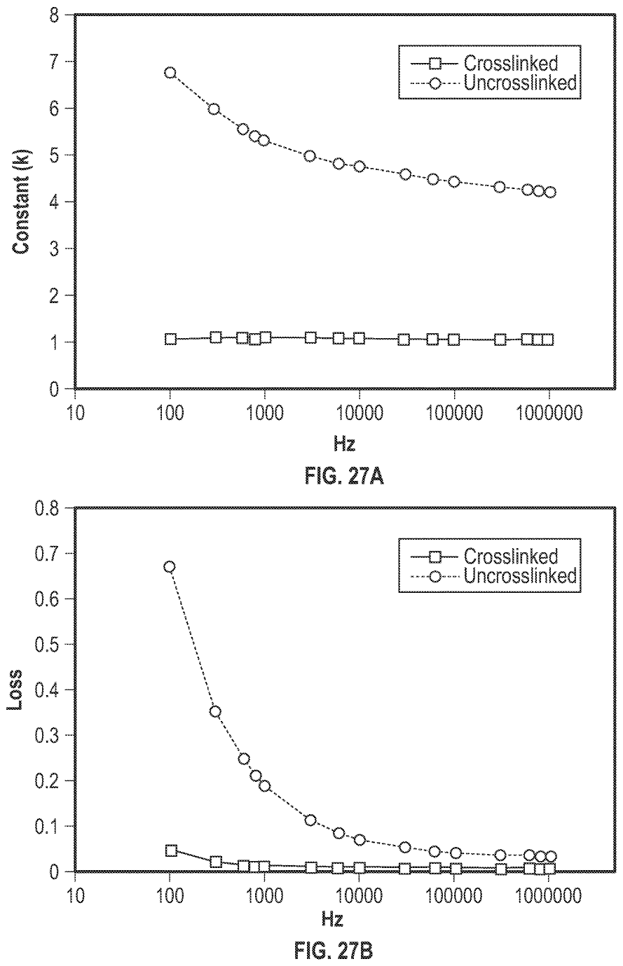

FIG. 24 illustrates thickness versus BL number for 0.2 wt % PEI+0.5 wt % mica/0.5 wt % PAA+0.5 wt % h-BN. FIGS. 25A-F illustrate dielectric constant versus frequency and dielectric loss versus frequency for crosslinked and uncrosslinked 0.2 wt % PEI +0.5 wt % mica/0.5 wt % PAA+0.5 wt % h-BN with 6 bilayers (FIGS. 25A and 25B), 8 bilayers (FIGS. 25C and 25D), and 10 bilayers (FIGS. 25E and 25F). FIG. 26 illustrates thermal conductivity versus dielectric constant for various materials, including for 0.2 wt % PEI+0.5 wt % mica/0.5 wt % PAA+0.5 wt % h-BN. FIG. 27A illustrates dielectric constant versus frequency for crosslinked and uncrosslinked 0.2 wt % PEI+0.5 wt % mica/0.5 wt % PAA+0.5 wt % h-BN with 6 bilayers, and FIG. 27B illustrates dielectric loss versus frequency for crosslinked and uncrosslinked 0.2 wt % PEI+0.5 wt % mica/0.5 wt % PAA+0.5 wt % h-BN with 6 bilayers.

The terms and expressions that have been employed are used as terms of description and not of limitation, and there is no intention in the use of such terms and expressions of excluding any equivalents of the features shown and described or portions thereof, but it is recognized that various modifications are possible within the scope of the aspects of the present invention. Thus, it should be understood that although the present invention has been specifically disclosed by specific aspects and optional features, modification and variation of the concepts herein disclosed may be resorted to by those of ordinary skill in the art, and that such modifications and variations are considered to be within the scope of aspects of the present invention.

### Exemplary Aspects

The following exemplary aspects are provided, the numbering of which is not to be construed as designating levels of importance:

Aspect 1 provides a nanocomposite comprising:
a stack comprising at least one bilayer, wherein each of the bilayers independently comprises
   an anionic layer comprising a polyanionic polymer, first particles, or a combination thereof, and
   a cationic layer comprising a polycationic polymer, second particles, or a combination thereof, wherein the anionic layer is in planar contact with the cationic layer;
wherein in each of the bilayers, the anionic layer comprises the polyanionic polymer, the cationic layer comprises the polycationic polymer, or a combination thereof.

Aspect 2 provides the nanocomposite of Aspect 1, wherein the nanocomposite comprises at least two of the bilayers, wherein the at least two bilayers are adjacent bilayers, wherein the anionic layer of one of the at least two bilayers is in planar contact with the cationic layer of another one of the at least two bilayers.

Aspect 3 provides the nanocomposite of any one of Aspects 1-2, wherein the anionic layer and the cationic layer of the two or more bilayers form an alternating arrangement in the stack.

Aspect 4 provides the nanocomposite of any one of Aspects 1-3, wherein the anionic layer comprises the polyanionic polymer, and wherein the cationic layer comprises the polycationic polymer and the second particles.

Aspect 5 provides the nanocomposite of any one of Aspects 1-4, wherein the anionic layer comprises the polyanionic polymer and the first particles, and wherein the cationic layer comprises the polycationic polymer.

Aspect 6 provides the nanocomposite of any one of Aspects 1-5, wherein the nanocomposite consists of the one or more bilayers.

Aspect 7 provides the nanocomposite of any one of Aspects 1-6, wherein the nanocomposite further comprises one or more additional bilayers, the additional bilayers independently comprising:
an additional anionic layer comprising the first particles, and
an additional cationic layer comprising the second particles, wherein the additional anionic layer is in planar contact with the additional cationic layer;
wherein
   at least one of the additional anionic layers is in planar contact with the cationic layer of at least one of the bilayers, or
   at least one of the additional cationic layers is in planar contact with the anionic layer of at least one of the bilayers, or
   a combination thereof.

Aspect 8 provides the nanocomposite of any one of Aspects 1-7, wherein the nanocomposite consists of the one or more bilayers and the one or more additional bilayers.

Aspect 9 provides the nanocomposite of any one of Aspects 1-8, wherein the anionic layer comprises the polyanionic polymer and the first particles, and wherein the cationic layer comprises the polycationic polymer and the second particles.

Aspect 10 provides the nanocomposite of any one of Aspects 1-9, wherein the stack has a thickness of 1 nm to 1,000 microns.

Aspect 11 provides the nanocomposite of any one of Aspects 1-10, wherein the stack has a thickness of 10 nm to 20 microns.

Aspect 12 provides the nanocomposite of any one of Aspects 1-11, wherein the stack comprises 1 to 2,000 of the bilayers.

Aspect 13 provides the nanocomposite of any one of Aspects 1-12, wherein the stack comprises 1 to 20 of the bilayers.

Aspect 14 provides the nanocomposite of any one of Aspects 1-13, wherein the stack comprises 2 to 12 of the bilayers.

Aspect 15 provides the nanocomposite of any one of Aspects 1-14, wherein each of the bilayers has a thickness of 2 nm to 400 nm.

Aspect 16 provides the nanocomposite of any one of Aspects 1-15, wherein each of the bilayers has a thickness of 2 nm to 100 nm.

Aspect 17 provides the nanocomposite of any one of Aspects 1-16, wherein the polyanionic polymer comprises polyacrylic acid, polystyrene sulfonate, poly(vinylsulfonic acid), poly(methyl vinyl ether-alt-maleic acid), poly(methacrylic acid), or a combination thereof.

Aspect 18 provides the nanocomposite of any one of Aspects 1-17, wherein the polyanionic polymer has a weight average molecular weight of 100 g/mol to 4,000,000 g/mol.

Aspect 19 provides the nanocomposite of any one of Aspects 1-18, wherein the polyanionic polymer has a weight average molecular weight of 500 g/mol to 500,000 g/mol.

Aspect 20 provides the nanocomposite of any one of Aspects 1-19, wherein the polycationic polymer comprises chitosan, polyethylenimine, polyvinyl amine, poly(diallylmethylammonium chloride), poly(allylamine), or a combination thereof.

Aspect 21 provides the nanocomposite of any one of Aspects 1-20, wherein the polycationic polymer has a weight average molecular weight of 100 g/mol to 4,000,000 g/mol.

Aspect 22 provides the nanocomposite of any one of Aspects 1-21, wherein the polycationic polymer has a weight average molecular weight of 500 g/mol to 50,000 g/mol.

Aspect 23 provides the nanocomposite of any one of Aspects 1-22, wherein the first and second particle independently have a median particle size of 1 nm to 10 microns.

Aspect 24 provides the nanocomposite of any one of Aspects 1-23, wherein the first and second particles independently have a median particle size of 1 nm to 100 nm.

Aspect 25 provides the nanocomposite of any one of Aspects 1-24, wherein the first and second particles independently comprise clay, boehmite, hexagonal boron nitride, graphene oxide, nanocellulose, colloidal silica, mica, MXenes, vermiculite, montmorillonite, laponite, halloysite, or a combination thereof.

Aspect 26 provides the nanocomposite of any one of Aspects 1-25, wherein the first and second particles independently comprise montmorillonite, vermiculite, hexagonal boron nitride, mica, or a combination thereof.

Aspect 27 provides the nanocomposite of any one of Aspects 1-26, wherein the nanocomposite is 10 wt % to 80 wt % inorganic materials.

Aspect 28 provides the nanocomposite of any one of Aspects 1-27, wherein the nanocomposite is 15 wt % to 65 wt % inorganic materials.

Aspect 29 provides the nanocomposite of any one of Aspects 1-28, wherein the cationic layer has a weight ratio of the particles to the polycationic polymer of 100:1 to 1:2.

Aspect 30 provides the nanocomposite of any one of Aspects 1-29, wherein the cationic layer has a weight ratio of the particles to the polycationic polymer of 10:1 to 5:1.

Aspect 31 provides the nanocomposite of any one of Aspects 1-30, wherein the anionic layer has a weight ratio of the particles to the polyanionic polymer of 100:1 to 0.5:1.

Aspect 32 provides the nanocomposite of any one of Aspects 1-31, wherein the anionic layer has a weight ratio of the particles to the polyanionic polymer of 10:1 to 1:1.

Aspect 33 provides the nanocomposite of any one of Aspects 1-32, wherein 0 wt % to 100 wt % or 0 wt % to 80 wt % of the anionic layer is the first particles.

Aspect 34 provides the nanocomposite of any one of Aspects 1-33, wherein 0 wt % to 100 wt % or 0 wt % to 80 wt % of the cationic layer is the second particles.

Aspect 35 provides the nanocomposite of any one of Aspects 1-34, wherein at each occurrence the anionic layer independently has a thickness of 1 nm to 3 microns.

Aspect 36 provides the nanocomposite of any one of Aspects 1-35, wherein at each occurrence the anionic layer independently has a thickness of 1 nm to 100 nm.

Aspect 37 provides the nanocomposite of any one of Aspects 1-36, wherein the anionic layer comprises polyacrylic acid, polystyrene sulfonate, poly(vinylsulfonic acid), poly(methyl vinyl ether-alt-maleic acid), poly(methacrylic acid), vermiculite, hexagonal boron nitride, or a combination thereof.

Aspect 38 provides the nanocomposite of any one of Aspects 1-37, wherein the anionic layer is formed from treatment with a solution comprising the polyanionic polymer, the first particles, or a combination thereof.

Aspect 39 provides the nanocomposite of any one of Aspects 1-38, wherein at each occurrence the cationic layer independently has a thickness of 1 nm to 3 microns.

Aspect 40 provides the nanocomposite of any one of Aspects 1-39, wherein at each occurrence the cationic layer independently has a thickness of 1 nm to 100 nm.

Aspect 41 provides the nanocomposite of any one of Aspects 1-40, wherein the cationic layer comprises chitosan, polyethylenimine, polyvinyl amine, poly(diallylmethylammonium chloride), poly(allylamine), boehmite, mica, or a combination thereof.

Aspect 42 provides the nanocomposite of any one of Aspects 1-41, wherein the cationic layer is formed from treatment with a solution comprising the polycationic polymer, the second particles, or a combination thereof.

Aspect 43 provides the nanocomposite of any one of Aspects 1-42, wherein the anionic layer comprises the polyanionic polymer and the cationic layer comprises the polycationic polymer, and wherein the polyanionic polymer and the polycationic polymer are crosslinked.

Aspect 44 provides the nanocomposite of any one of Aspects 1-43, wherein the anionic layer comprises the polyanionic polymer and the cationic layer comprises the polycationic polymer, and wherein the polyanionic polymer and the polycationic polymer are substantially free of crosslinking.

Aspect 45 provides the nanocomposite of any one of Aspects 1-44, wherein the nanocomposite is on a substrate.

Aspect 46 provides the nanocomposite of Aspect 45, wherein the substrate comprises glass, metal, polymer, mineral, fabric, or a combination thereof.

Aspect 47 provides the nanocomposite of any one of Aspects 1-46, wherein the nanocomposite has a thermal conductivity (k_{⊥}) of 0.01 w/m*K to 5 w/m*K.

Aspect 48 provides the nanocomposite of any one of Aspects 1-47, wherein the nanocomposite has a thermal conductivity (k_{⊥}) of 0.19 w/m*K to 0.86 w/m*K.

Aspect 49 provides the nanocomposite of any one of Aspects 1-48, wherein the nanocomposite has a dielectric breakdown strength at room temperature of 100 kV/mm to 300 kV/mm.

Aspect 50 provides the nanocomposite of any one of Aspects 1-49, wherein the nanocomposite has a dielectric breakdown strength at room temperature of 10 kV/mm to 4,000 kV/mm.

Aspect 51 provides the nanocomposite of any one of Aspects 1-50, wherein the nanocomposite has an effective thermal conductivity (k_{eff}) of 0.05 W/m*K to 5 W/m*K.

Aspect 52 provides the nanocomposite of any one of Aspects 1-51, wherein the nanocomposite has an effective thermal conductivity (k_{eff}) of 0.10 W/m*K to 0.2 W/m*K.

Aspect 53 provides the nanocomposite of any one of Aspects 1-52, wherein thermal conductivity of the nanocomposite times dielectric breakdown strength of the nanocomposite at room temperature is 20 kW*MV/m²*K to 200 kW*MV/m²*K.

Aspect 54 provides the nanocomposite of any one of Aspects 1-53, wherein thermal conductivity of the nanocomposite times dielectric breakdown strength of the nanocomposite at room temperature is 33 kW*MV/m²*K to 150 kW*MV/m²*K.

Aspect 55 provides the nanocomposite of any one of Aspects 1-54, wherein the nanocomposite has a dielectric constant at room temperature and at 1 kHz of 1 to 50.

Aspect 56 provides the nanocomposite of any one of Aspects 1-55, wherein the nanocomposite has a dielectric constant at room temperature and at 1 kHz of 2 to 15.

Aspect 57 provides the nanocomposite of any one of Aspects 1-56, wherein the nanocomposite is optically transparent.

Aspect 58 provides the nanocomposite of any one of Aspects 1-57, wherein the nanocomposite is optically opaque.

Aspect 59 provides a nanocomposite comprising:
a stack comprising at least two bilayers in planar contact with one another, wherein each of the bilayers independently comprises
   an anionic layer comprising polyethylenimine and first particles comprising boehmite, mica, or a combination thereof, and
   a cationic layer comprising polyacrylic acid and second particles comprising vermiculite, hexagonal boron nitride, or a combination thereof, wherein the anionic layer is in planar contact with the cationic layer;
wherein the anionic layer and the cationic layer of the two or more bilayers form an alternating arrangement in the stack, and wherein thermal conductivity of the nanocomposite times dielectric breakdown strength of the nanocomposite at room temperature is 33 kW*MV/m²*K to 150 kW*MV/m²*K.

Aspect 60 provides an electrical device comprising the nanocomposite of any one of Aspects 1-59.

Aspect 61 provides a method of forming the nanocomposite of any one of Aspects 1-59, the method comprising:
treating a substrate with an anionic solution comprising the polyanionic polymer, the first particles, or a combination thereof,
before or after treating the substrate with the anionic solution, treating the substrate with a cationic solution comprising the polycationic polymer, the second particles, or a combination thereof, and
repeating the treating of the substrate with the anionic solution and the treating of the substrate with the cationic solution in an alternating fashion, to form the nanocomposite;
wherein the anionic solution comprises the polyanionic polymer, the cationic solution comprises the polycationic polymer, or a combination thereof.

Aspect 62 provides the method of Aspect 61, wherein the treating of the substrate with the anionic solution and the cationic solution comprises dipping and/or immersing the substrate in the respective solution.

Aspect 63 provides the method of any one of Aspects 61-62, wherein the treating of the substrate with the anionic solution and the cationic solution comprises dipping and/or immersing the substrate in the respective solution for a duration of 1 sec to 1 h.

Aspect 64 provides the method of any one of Aspects 61-63, wherein the treating of the substrate with the anionic solution and the cationic solution comprises dipping and/or immersing the substrate in the respective solution for a duration of 30 sec to 10 min.

Aspect 65 provides the method of any one of Aspects 61-64, wherein the cationic solution and the anionic solution are each aqueous solutions.

Aspect 66 provides the method of any one of Aspects 61-65, wherein the cationic solution has a pH of 1 to 13.

Aspect 67 provides the method of any one of Aspects 61-66, wherein the cationic solution has a pH of 8 to 10.

Aspect 68 provides the method of any one of Aspects 61-67, wherein the anionic solution has a pH of 1 to 13.

Aspect 69 provides the method of any one of Aspects 61-68, wherein the anionic solution has a pH of 4 to 6.

Aspect 70 provides the method of any one of Aspects 61-69, wherein the cationic solution has a weight ratio of the particles to the polycationic polymer of 100:1 to 1:2.

Aspect 71 provides the method of any one of Aspects 61-70, wherein the cationic solution has a weight ratio of the particles to the polycationic polymer of 10:1 to 5:1.

Aspect 72 provides the method of any one of Aspects 61-71, wherein the cationic solution comprises 0.01 wt % to 20 wt % particles and 0.01 wt % to 1 wt % polycationic polymer.

Aspect 73 provides the method of any one of Aspects 61-72, wherein the cationic solution comprises 0.4 to 1 wt % particles and 0.05 to 0.5 wt % polycationic polymer.

Aspect 74 provides the method of any one of Aspects 61-73, wherein the anionic solution has a weight ratio of the particles to the polyanionic polymer of 100:1 to 0.5:1.

Aspect 75 provides the method of any one of Aspects 61-74, wherein the anionic solution has a weight ratio of the particles to the polyanionic polymer of 10:1 to 1:1.

Aspect 76 provides the method of any one of Aspects 61-75, wherein the anionic solution comprises 0.01 wt % to 20 wt % particles and 0.01 wt % to 5 wt % polyanionic polymer.

Aspect 77 provides the method of any one of Aspects 61-76, wherein the anionic solution comprises 0.4 wt % to 1.5 wt % particles and 0.05 wt % to 0.7 wt % polyanionic polymer.

Aspect 78 provides the method of any one of Aspects 61-77, further comprising rinsing the treated substrate after treating the substrate with the anionic solution and/or the cationic solution.

Aspect 79 provides the method of any one of Aspects 61-78, further comprising drying the treated substrate after treating the substrate with the anionic solution and/or the cationic solution.

Aspect 80 provides the method of any one of Aspects 61-79, further comprising heat treating the treated substrate to crosslink polyanionic and polycationic layers of the nanocomposite.

Aspect 81 provides a method of forming a nanocomposite, the method comprising:
treating a substrate with an anionic solution comprising polyethylenimine and first particles comprising boehmite, mica, or a combination thereof,
before or after treating the substrate with the anionic solution, treating the substrate with a cationic solution comprising polyacrylic acid and second particles comprising vermiculite, hexagonal boron nitride, or a combination thereof, and
repeating the treating of the substrate with the anionic solution and the treating of the substrate with the cationic solution in an alternating fashion, to form the nanocomposite comprising
   a stack comprising at least two adjacent bilayers in planar contact with one another, wherein each of the bilayers independently comprises
      an anionic layer comprising polyethylenimine and first particles comprising boehmite, mica, or a combination thereof, and
      a cationic layer comprising polyacrylic acid and second particles comprising vermiculite, hexagonal boron nitride, or a combination thereof, wherein the anionic layer is in planar contact with the cationic layer;
   wherein the anionic layer and the cationic layer of the two or more bilayers form an alternating arrangement in the stack, and wherein thermal conductivity of the nanocomposite times dielectric breakdown strength of the nanocomposite at room temperature is 33 kW*MV/m²*K to 150 kW*MV/m²*K.

Aspect 82 provides the nanocomposite, electrical device, or method of any one or any combination of Aspects 1-81 optionally configured such that all elements or options recited are available to use or select from.

What is claimed is:

1. A nanocomposite comprising:
a stack comprising at least one bilayer, wherein each of the bilayers independently comprises
an anionic layer comprising a polyanionic polymer, first particles, or a combination thereof, and
a cationic layer comprising a polycationic polymer, second particles, or a combination thereof, wherein the anionic layer is in planar contact with the cationic layer;
wherein in each of the bilayers, the anionic layer comprises the polyanionic polymer, the cationic layer comprises the polycationic polymer, or a combination thereof.

2. The nanocomposite of claim 1, wherein the nanocomposite comprises at least two of the bilayers, wherein the at least two bilayers are adjacent bilayers, wherein the anionic layer and the cationic layer of the two or more bilayers form an alternating arrangement in the stack.

3. The nanocomposite of claim 1, wherein the nanocomposite further comprises one or more additional bilayers, the additional bilayers independently comprising:
an additional anionic layer comprising the first particles, and
an additional cationic layer comprising the second particles, wherein the additional anionic layer is in planar contact with the additional cationic layer;
wherein
at least one of the additional anionic layers is in planar contact with the cationic layer of at least one of the bilayers, or
at least one of the additional cationic layers is in planar contact with the anionic layer of at least one of the bilayers, or
a combination thereof.

4. The nanocomposite of claim 1, wherein the anionic layer comprises the polyanionic polymer and the first particles, and wherein the cationic layer comprises the polycationic polymer and the second particles.

5. The nanocomposite of claim 1, wherein the stack has a thickness of 1 nm to 1,000 microns, and wherein the stack comprises 1 to 2,000 of the bilayers.

6. The nanocomposite of claim 1, wherein the polyanionic polymer comprises polyacrylic acid, polystyrene sulfonate, poly(vinylsulfonic acid), poly(methyl vinyl ether-alt-maleic acid), poly(methacrylic acid), or a combination thereof.

7. The nanocomposite of claim 1, wherein the polycationic polymer comprises chitosan, polyethylenimine, polyvinyl amine, poly(diallylmethylammonium chloride), poly(allylamine), or a combination thereof.

8. The nanocomposite of claim 1, wherein the first and second particles independently comprise clay, boehmite, hexagonal boron nitride, graphene oxide, nanocellulose, colloidal silica, mica, MXenes, vermiculite, montmorillonite, laponite, halloysite, or a combination thereof, and wherein the first and second particles independently have a median particle size of 1 nm to 10 microns.

9. The nanocomposite of claim 1, wherein the cationic layer has a weight ratio of the particles to the polycationic polymer of 100:1 to 1:2, and wherein the anionic layer has a weight ratio of the particles to the polyanionic polymer of 100:1 to 0.5:1.

10. The nanocomposite of claim 1, wherein at each occurrence the anionic layer independently has a thickness of 1 nm to 100 nm, and at each occurrence the cationic layer independently has a thickness of 1 nm to 100 nm.

11. The nanocomposite of claim 1, wherein the anionic layer comprises the polyanionic polymer and the cationic layer comprises the polycationic polymer, and wherein the polyanionic polymer and the polycationic polymer are covalently crosslinked therebetween.

12. The nanocomposite of claim 1, wherein the anionic layer comprises the polyanionic polymer and the cationic layer comprises the polycationic polymer, and wherein the polyanionic polymer and the polycationic polymer are substantially free of covalent crosslinking therebetween.

13. The nanocomposite of claim 1, wherein the nanocomposite is on a substrate, wherein the substrate comprises glass, metal, polymer, mineral, fabric, or a combination thereof.

14. The nanocomposite of claim 1, wherein the nanocomposite has a thermal conductivity (k_{⊥}) of 0.01 w/m*K to 5 w/m*K, the nanocomposite has a dielectric breakdown strength at room temperature of 10 kV/mm to 4,000 kV/mm, and wherein thermal conductivity of the nanocomposite times dielectric breakdown strength of the nanocomposite at room temperature is 20 kW*MV/m²*K to 200 kW*MV/m²*K.

15. An electrical device comprising the nanocomposite of claim 1.

16. A nanocomposite comprising:
a stack comprising at least two bilayers in planar contact with one another, wherein each of the bilayers independently comprises
an anionic layer comprising polyacrylic acid and first particles comprising vermiculite, hexagonal boron nitride, or a combination thereof, and
a cationic layer comprising polyethylenimine and second particles comprising boehmite, mica, or a combination thereof, wherein the anionic layer is in planar contact with the cationic layer;
wherein the anionic layer and the cationic layer of the two or more bilayers form an alternating arrangement in the stack, and wherein thermal conductivity of the nanocomposite times dielectric breakdown strength of the nanocomposite at room temperature is 33 kW*MV/m²*K to 150 kW*MV/m²*K.

17. A method of forming the nanocomposite of claim 1, the method comprising:
treating a substrate with an anionic solution comprising the polyanionic polymer, the first particles, or a combination thereof,
before or after treating the substrate with the anionic solution, treating the substrate with a cationic solution comprising the polycationic polymer, the second particles, or a combination thereof; and
repeating the treating of the substrate with the anionic solution and the treating of the substrate with the cationic solution in an alternating fashion, to form the nanocomposite;
wherein the anionic solution comprises the polyanionic polymer, the cationic solution comprises the polycationic polymer, or a combination thereof.

18. The method of claim 17, wherein the treating of the substrate with the anionic solution and the cationic solution comprises dipping and/or immersing the substrate in the respective solution for a duration of 1 sec to 10 h.

19. The method of claim 17, wherein the cationic solution has a pH of 7.5 to 11, and wherein the anionic solution has a pH of 3 to 6.5.

20. A method of forming a nanocomposite, the method comprising:
treating a substrate with an anionic solution comprising polyacrylic acid and first particles comprising vermiculite, hexagonal boron nitride, or a combination thereof,
before or after treating the substrate with the anionic solution, treating the substrate with a cationic solution comprising polyethylenimine and first particles comprising boehmite, mica, or a combination thereof, and
repeating the treating of the substrate with the anionic solution and the treating of the substrate with the cationic solution in an alternating fashion, to form the nanocomposite comprising
a stack comprising at least two adjacent bilayers in planar contact with one another, wherein each of the bilayers independently comprises
an anionic layer comprising polyacrylic acid and first particles comprising vermiculite, hexagonal boron nitride, or a combination thereof, and
a cationic layer comprising polyethylenimine and second particles comprising boehmite, mica, or a combination thereof, wherein the anionic layer is in planar contact with the cationic layer;
wherein the anionic layer and the cationic layer of the two or more bilayers form an alternating arrangement in the stack, and wherein thermal conductivity of the nanocomposite times dielectric breakdown strength of the nanocomposite at room temperature is 33 kW*MV/m²*K to 150 kW*MV/m²*K.
